(19) United States
(12) Patent Application Publication
(10) Pub. No.: US 2025/0279833 A1
(43) Pub. Date: Sep. 4, 2025

(54) TRANSMITTER, TRANSMISSION DEVICE, COMMUNICATION DEVICE, AND COMMUNICATION SYSTEM

(71) Applicant: NEC Corporation, Tokyo (JP)

(72) Inventors: Hisashi Mizumoto, Tokyo (JP); Fujio Okumura, Kanagawa (JP)

(73) Assignee: NEC Corporation, Tokyo (JP)

(21) Appl. No.: 18/592,888

(22) Filed: Mar. 1, 2024

(51) Int. Cl. H04B 10/50

(52) U.S. Cl. CPC H04B 10/503; H04B 10/506

(57) ABSTRACT

A transmitter including a light source that emits illumination light, a first annular mirror array and a second annular mirror array that includes reflectors arranged in an annular shape, and a spatial light modulator that includes a modulation part that emits the illumination light emitted from the light source, and emits the modulation light modulated by the modulation part toward at least one of the first annular mirror array and the second annular mirror array. A plurality of reflectors constituting the first annular mirror array and the second annular mirror array are arranged such that the modulation light emitted from the spatial light modulator is reflected laterally. A reflecting surface of each of the reflectors constituting the second annular mirror array is oriented in a direction including a blind region of any reflecting surface of the reflectors constituting the first annular mirror array.

This application is based upon and claims the benefit of priority from Japanese

Patent Application No. 2023-041528, filed on Mar. 16, 2023, the disclosure of which is incorporated herein in its entirety by reference.

### TECHNICAL FIELD

The present disclosure relates to a transmitter, a transmission device, a communication device, and a communication system.

### BACKGROUND ART

In optical spatial communication, optical signals (hereinafter, also referred to as a spatial optical signal) propagating in space are transmitted and received without using a medium such as an optical fiber. For example, if a transmission device including a phase modulation-type spatial light modulator is used, the spatial optical signal can be transmitted in various direction by controlling a pattern set in the modulation part of the spatial light modulator. By transmitting the spatial optical signal in multiple directions around the transmission device, a communication network using the spatial optical signal can be constructed.

In general spatial light communication, an adjustment mechanism for adjusting a transmission/reception direction of a spatial optical signal is required in order to transmit the spatial optical signal in various directions. When the direction of the communication target is unknown, it is necessary to visually confirm the direction of the communication target or adjust the transmission/reception direction through communication between the communication devices. As described above, it takes labor and time to install the communication device that transmits and receives the spatial optical signal.

PTL 1 (JP 2018-026095 A) discloses an optical transmission/reception device for transmitting and receiving optical signals between traveling vehicles. The device of PTL 1 includes a light emitting unit, a light receiving unit, and an omnidirectional optical component. In the device of PTL 1, the optical axis on which the optical signal transmitted from the light emitting unit is incident on the optical component and the optical axis on which the optical signal transmitted from another vehicle and incident on the optical component is emitted from the optical component are the same optical axis. The device of PTL 1 transmits an optical signal in all external directions in a substantially horizontal direction through an optical component, and receives an optical signal from all directions in the substantially horizontal direction transmitted from another vehicle. In this way, the device of PTL 1 performs omnidirectional transmission and reception to and from an unspecified vehicle. The device of PTL 1 receives an optical signal transmitted from a specific other vehicle while transmitting an optical signal transmitted from one light emitting element toward the specific other vehicle through an omnidirectional optical component. In this way, the device of PTL 1 performs one-to-one communication with a specific other vehicle.

In the method of PTL 1, a communication target is detected by omnidirectional transmission and reception, and individual optical signals (individual signals) are transmitted toward a single detected communication target. In the method of PTL 1, an optical signal is transmitted via a rotating body having a curved translucent surface. Therefore, in the method of PTL 1, the beam diameter of the optical signal increases as the distance from the optical transmission/reception device increases according to the curvature of the light-transmitting surface, and the optical signal is easily attenuated. On the other hand, in a case where the flat mirror is used instead of the curved light transmitting surface, attenuation of the optical signal is reduced, but a blind region where the optical signal cannot be transmitted increases.

An object of the present disclosure is to provide a transmitter or the like capable of transmitting a spatial optical signal that is hardly attenuated in an arbitrary direction along a horizontal plane.

### SUMMARY

A transmitter according to one aspect of the present disclosure includes a light source that emits illumination light, a first annular mirror array that includes a plurality of reflectors arranged in an annular shape around an optical axis of the illumination light, a second annular mirror array that includes a plurality of reflectors arranged in an annular shape around an optical axis of the illumination light in a region inside the first annular mirror array in plan view, and a spatial light modulator that includes a modulation part that emits the illumination light emitted from the light source, and emits the modulation light modulated by the modulation part toward at least one of the first annular mirror array and the second annular mirror array. A plurality of reflectors constituting the first annular mirror array and the second annular mirror array are arranged in such a way that the modulation light emitted from the spatial light modulator is reflected laterally. A reflecting surface of each of the plurality of reflectors constituting the second annular mirror array is oriented in a direction including a blind region of any reflecting surface of the plurality of reflectors constituting the first annular mirror array.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device according to the present disclosure;

FIG. 2 is a conceptual diagram illustrating an arrangement example of a first annular mirror array and a second annular mirror array included in a transmission device according to the present disclosure;

FIG. 3 is a conceptual diagram illustrating a setting example of a modulation region in a modulation part of a spatial light modulator included in a transmission device according to the present disclosure;

FIG. 4 is a conceptual diagram for explaining a projection region of a spatial optical signal by a first annular mirror array included in a transmission device according to the present disclosure;

FIG. 5 is a conceptual diagram for explaining a projection region of a spatial optical signal by a combination of a first annular mirror array and a second annular mirror array included in a transmission device according to the present disclosure;

FIG. 6 is a conceptual diagram for explaining a projection example of a spatial optical signal using a first annular mirror array and a second annular mirror array included in a transmission device according to the present disclosure;

FIG. 7 is a conceptual diagram for explaining a projection example of a spatial optical signal using a first annular mirror array and a second annular mirror array included in a transmission device according to the present disclosure;

FIG. 8 is a conceptual diagram illustrating an example of a housing of a transmission device according to the present disclosure;

FIG. 9 is a conceptual diagram for explaining a projection example of a spatial optical signal using a first annular mirror array and a second annular mirror array included in a transmission device according to the present disclosure;

FIG. 10 is a conceptual diagram illustrating an example of a configuration of a transmission device according to a first modification of the present disclosure;

FIG. 11 is a conceptual diagram for explaining a projection example of a spatial optical signal using a first annular mirror array and a second annular mirror array included in a transmission device according to a first modification of the present disclosure;

FIG. 12 is a conceptual diagram illustrating an example of a configuration of a transmission device according to the present disclosure;

FIG. 13 is a conceptual diagram illustrating an arrangement example of a first annular relay mirror, a first annular mirror array, and a second annular mirror array included in a transmission device according to the present disclosure;

FIG. 14 is a conceptual diagram illustrating an arrangement example of a second annular relay mirror included in a transmission device according to the present disclosure;

FIG. 15 is a conceptual diagram illustrating an example of a configuration of a transmission device according to a second modification of the present disclosure;

FIG. 16 is a conceptual diagram illustrating an example of a configuration of a transmission device according to a third modification of the present disclosure;

FIG. 17 is a conceptual diagram illustrating an example of a configuration of a transmission device according to the present disclosure;

FIG. 18 is a conceptual diagram for explaining an optical power measuring mode by a transmission device according to the present disclosure;

FIG. 19 is a block diagram illustrating an example of a configuration of a communication device according to the present disclosure;

FIG. 20 is a conceptual diagram illustrating an example of a configuration of a receiver included in a communication device according to the present disclosure;

FIG. 21 is a conceptual diagram for explaining transmission/reception of a spatial optical signal by a communication device according to the present disclosure;

FIG. 22 is a conceptual diagram for explaining an application example of a communication device according to the present disclosure;

FIG. 23 is a block diagram illustrating an example of a configuration of a transmitter according to the present disclosure; and

FIG. 24 is a block diagram illustrating a hardware configuration example that executes control and processing according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. A line indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated or the configuration is complicated.

### First Example Embodiment

First, a transmission device according to a first example embodiment will be described with reference to the drawings. The transmission device of the present example embodiment is used for optical spatial communication in which an optical signal (hereinafter, also referred to as a spatial optical signal) propagating in a space are transmitted and received. The transmission device of the present example embodiment may be used for applications other than optical spatial communication as long as the transmission device transmits light propagating in a space. The drawings used in the description of the present example embodiment are conceptual and do not accurately depict an actual structure.

### (Configuration)

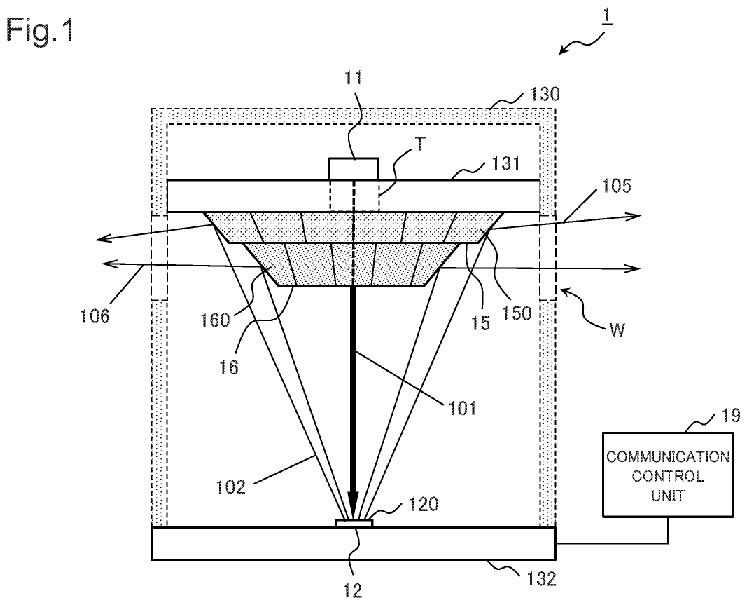

FIG. 1 is a conceptual diagram illustrating an example of a configuration of a transmission device 1 according to the present example embodiment. The transmission device 1 includes a light source 11, a spatial light modulator 12, a first annular mirror array 15, a second annular mirror array 16, and a communication control unit 19. The light source 11, the spatial light modulator 12, the first annular mirror array 15, and the second annular mirror array 16 constitute a transmitter. The transmitter is stored in a housing 130 in which a window W for transmitting a spatial optical signal is formed. FIG. 1 is a diagram of an internal configuration of the transmission device 1 housed in the housing 130 as viewed from a side perspective. FIG. 1 illustrates the housing 130 cut at a portion of the window W. FIG. 1 is conceptual, and does not accurately represent a shape of each component, a positional relationship between components, traveling of light, and the like. The configuration of FIG. 1 may be arranged in a state where the upper and lower sides are inverted.

FIG. 1 illustrates a top plate 131 that supports the light source 11, the first annular mirror array 15, and the second annular mirror array 16. The first annular mirror array 15 and the second annular mirror array 16 are disposed on the lower surface of the top plate 131. FIG. 1 illustrates a bottom plate 132 on which the spatial light modulator 12 is disposed. The spatial light modulator 12 is disposed on the upper surface of the bottom plate 132.

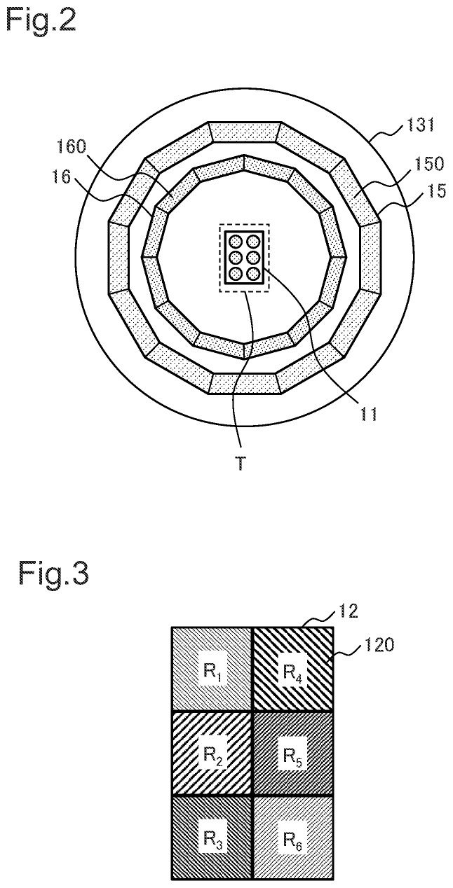

FIG. 2 is a conceptual diagram of the top plate 131 as viewed from a lower perspective. A through hole T is opened at the center of the top plate 131. The through hole T is an opening for allowing an illumination light 101 emitted from the light source 11 to pass downward. In the example of FIG. 2, the opening shape of the through hole T is rectangular, but the opening shape of the through hole T may not be rectangular. The first annular mirror array 15 and the second annular mirror array 16 are arranged on the lower surface of the top plate 131. The first annular mirror array 15 and the second annular mirror array 16 are mirror arrays in which a plurality of reflectors are annularly arranged. The first annular mirror array 15 and the second annular mirror array 16 are arranged concentrically. The reflecting surfaces of the plurality of reflectors constituting the first annular mirror array 15 and the reflecting surfaces of the plurality of reflectors constituting the second annular mirror array 16 are both oriented in different directions.

The light source 11 emits the illumination light 101. An emission surface of the light source 11 is directed to a modulation part 120 of the spatial light modulator 12 via the through hole T of the top plate 131. The light source 11 may be disposed inside the through hole T of the top plate 131. The light source 11 may be disposed on the lower surface of the top plate 131 or between the top plate 131 and the spatial light modulator 12. In this case, the through hole T may not be formed in the top plate 131. The illumination light 101 emitted from the light source 11 passes through the through hole T and is applied to the modulation part 120 of the spatial light modulator 12.

The light source 11 includes a plurality of emitters (not illustrated). The emitter included in the light source 11 emits laser light in a predetermined wavelength band under the control of the communication control unit 19. The wavelength of the laser light emitted from the emitter is not particularly limited, and may be selected according to the application. For example, the emitter emits the laser light in visible or infrared wavelength bands. For example, in the case of near infrared rays of 800 to 1000 nanometers (nm), the laser class can be given compared to the visible light, and thus the sensitivity can be improved more than the visible light. For example, a laser light source having a higher output than the near infrared rays of 800 to 1000 nm for infrared rays can be used in a wavelength band of 1.55 micrometers (μm). As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 11 may be implemented by a surface emitting laser. The light source 11 is implemented by a PCSEL (Photonic Crystal Surface Emitting Laser) type laser. Since the PCSEL type laser emits laser light of annular narrow radiation, a collimator is unnecessary.

The spatial light modulator 12 is a phase modulation-type spatial light modulator. The spatial light modulator 12 includes the modulation part 120. A plurality of modulation regions are set in the modulation part 120. The number of modulation regions set in the modulation part 120 is set in accordance with the number of emitters included in the light source 11.

FIG. 3 is a conceptual diagram illustrating an example of a plurality of modulation regions R set in the modulation part 120. In the modulation part 120, the modulation region R is set according to the number of light emitters included in the light source 11. In the example of FIG. 3, six modulation regions R (R₁ to R₆) are set. A dead zone may be set between the adjacent modulation regions R. For example, a black lattice-shaped phase image is set in the dead zone. The dead zone may be set in any shape instead of the lattice shape of the modulation part 120.

Each of the plurality of modulation regions R is associated with one of the plurality of emitters included in the light source 11. A pattern (also referred to as a phase image) corresponding to the image displayed by projection light 105 or 106 is set in each of the plurality of modulation regions R under the control of the communication control unit 19. Each of the plurality of modulation regions R is irradiated with illumination light 101. The illumination light 101 is derived from the laser light emitted from the emitter associated with the modulation region R. The illumination light 101 incident on each of the plurality of modulation regions R is modulated according to a pattern (phase image) set in each of the plurality of modulation regions R. The modulation light 102 modulated in each of the plurality of modulation regions R travels toward a reflecting surface 150 of the first annular mirror array 15 or a reflecting surface 160 of the second annular mirror array 16.

The modulation region R is divided into a plurality of regions (also referred to as tiling). For example, the modulation region R is divided into square or rectangular regions (also referred to as tiles). Each of the plurality of tiles includes a plurality of pixels. A phase image relevant to a projected image is set to each of the plurality of tiles. The same phase image is tiled to each of the plurality of tiles allocated to the modulation region R. For example, a phase image generated in advance is set in each of the plurality of tiles. When the modulation region R is irradiated with the illumination light 101 in a state where the same phase image is set to the plurality of tiles, the modulation light 102 forming an image corresponding to the phase image is emitted. As the number of tiles set in the modulation region R increases, a clear image can be displayed. On the other hand, when the number of pixels of each tile decreases, the resolution decreases. Therefore, the size and number of tiles set in the modulation region R are set according to the application.

For example, the spatial light modulator 12 is achieved by a spatial light modulator using ferroelectric liquid crystal, homogeneous liquid crystal, vertical alignment liquid crystal, or the like. For example, the spatial light modulator 12 can be achieved by liquid crystal on silicon (LCOS). The spatial light modulator 12 may be achieved by a micro electro mechanical system (MEMS). In the spatial light modulator 12 of the phase modulation type, the energy can be concentrated on the portion of the image by operating to sequentially switch the portion on which the projection light 105 or 106 is projected. Therefore, in the case of using the spatial light modulator 12 of the phase modulation type, if the output of the emitter included in the light source 11 is the same, the image can be displayed brighter than other methods.

The modulation light 102 modulated by the modulation part 120 of the spatial light modulator 12 travels toward the reflecting surface 150 of the first annular mirror array 15 or the reflecting surface 160 of the second annular mirror array 16. The modulation light 102 traveling toward the reflecting surface 150 of the first annular mirror array 15 is reflected by the reflecting surface 150 and projected as projection light 105. The modulation light 102 traveling toward the reflecting surface 160 of the second annular mirror array 16 is reflected by the reflecting surface 160 and projected as projection light 106.

The first annular mirror array 15 has a configuration in which a plurality of reflectors (also referred to as first reflectors) are arranged in an annular shape. Each of the plurality of reflectors is a reflector having a reflecting surface 150 having a curvature at least in the vertical direction. In the example of FIG. 2, the 12 reflectors constituting the first annular mirror array 15 are annularly arranged with their reflecting surfaces 150 facing obliquely downward. The number of reflectors constituting the first annular mirror array 15 is not limited to 12. The diameter of the annular ring formed by the first annular mirror array 15 is larger than the diameter of the annular ring formed by the second annular mirror array 16. The second annular mirror array 16 is concentrically arranged inside the first annular mirror array 15.

The second annular mirror array 16 has a configuration in which a plurality of reflectors (also referred to as second reflectors) are arranged in an annular shape. Each of the plurality of reflectors is a reflector having a reflecting surface 160 having a curvature at least in the vertical direction. In the example of FIG. 2, the 12 reflectors constituting the second annular mirror array 16 are annularly arranged with their reflecting surfaces 160 facing obliquely downward. The number of reflectors constituting the second annular mirror array 16 is not limited to 12. In the example of FIG. 2, the number of reflectors constituting the second annular mirror array 16 is the same as the number of reflectors constituting the first annular mirror array 15. The number of reflectors constituting the second annular mirror array 16 may be different from the number of reflectors constituting the first annular mirror array 15. The size and shape of the reflector constituting the second annular mirror array 16 may be the same as or different from those of the reflector constituting the first annular mirror array 15. The diameter of the annular ring formed by the second annular mirror array 16 is smaller than the diameter of the annular ring formed by the first annular mirror array 15. The first annular mirror array 15 is concentrically arranged outside the second annular mirror array 16.

The reflecting surface 150 of the reflector constituting the first annular mirror array 15 and the reflecting surface 160 of the reflector constituting the second annular mirror array 16 are oriented in different directions in the horizontal plane. In the example of FIG. 2, the reflecting surface 160 of the reflector constituting the second annular mirror array 16 is directed to the boundary of the reflector constituting the first annular mirror array 15.

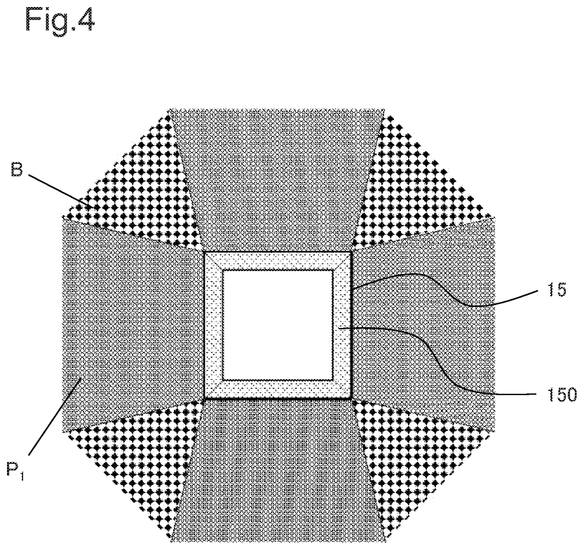

FIG. 4 is a conceptual diagram illustrating an example of the first annular mirror array 15 including four reflectors. FIG. 4 is a bottom view as viewed from a lower perspective. A blind region B is formed between projection regions P1 of light reflected by the reflecting surfaces 150 of the four reflectors constituting the first annular mirror array 15. The light reflected by the reflecting surface 150 is not projected in the blind region B.

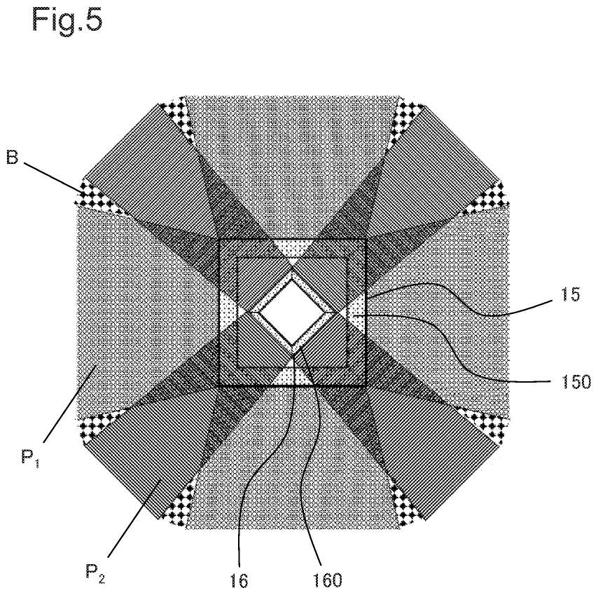

FIG. 5 is a conceptual diagram illustrating an example in which the second annular mirror array 16 including four reflectors is arranged inside the first annular mirror array 15 including four reflectors. FIG. 5 is a bottom view as viewed from a lower perspective. A projection region P2 of light reflected by the reflecting surfaces 160 of the four reflectors constituting the second annular mirror array 16 is formed between the projection regions P1 of light reflected by the reflecting surfaces 150 of the four reflectors constituting the first annular mirror array 15. The blind region B is formed between the projection region P1 and the projection region P2. The light reflected by the reflecting surface 150 is not projected in the blind region B.

As compared with the example (FIG. 4) in which the first annular mirror array 15 is arranged alone as illustrated in FIG. 5, the area of the blind region B is reduced by combining the first annular mirror array 15 and the second annular mirror array 16. FIGS. 4 to 5 illustrate an example in which the first annular mirror array 15 and the second annular mirror array 16 are configured by four reflectors. As the number of reflectors constituting the first annular mirror array 15 and the second annular mirror array 16 increases, the area of the blind region B decreases. In practice, by increasing the number of reflectors constituting the first annular mirror array 15 and the second annular mirror array 16, there is almost no blind region B.

The first annular mirror array 15 and the second annular mirror array 16 are irradiated with a light component to be projected (also referred to as desired light) out of the modulation light 102 modulated by the modulation part 120 of the spatial light modulator 12. The modulation light 102 irradiated to the reflecting surface 150 is reflected by the reflecting surface 150. The light (projection light 105) reflected by the reflecting surface 150 is projected as a spatial optical signal. Similarly, the modulation light 102 irradiated to the reflecting surface 160 is reflected by the reflecting surface 160. The light (projection light 106) reflected by the reflecting surface 160 is projected as a spatial optical signal. The projection light 106 is also projected on a region including blind region B where the projection light 105 is not projected. The projection light 105 is also projected on a region including blind region B where the projection light 106 is not projected. That is, the projection light 105 and the projection light 106 reduce the blind region B.

The reflecting surface 150 of the first annular mirror array 15 and the reflecting surface 160 of the second annular mirror array 16 are oriented in an azimuth of 360 degrees in the horizontal plane while complementing each other's blind region B. Therefore, by using the transmission device 1, the projection light 105 or 106 can be projected in a direction of 360 degrees in the horizontal plane by controlling the pattern (phase image) set in the modulation part 120 of the spatial light modulator 12.

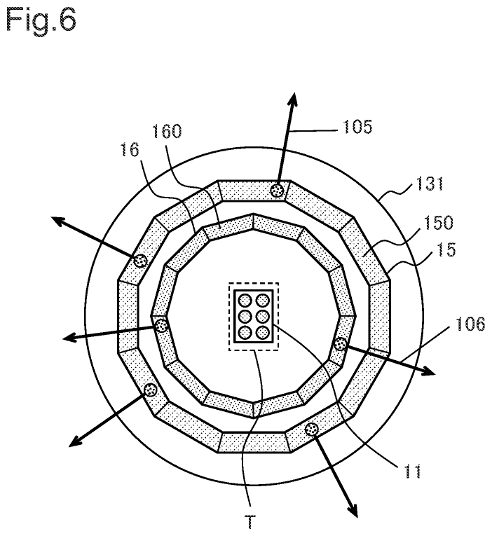

FIG. 6 is a conceptual diagram illustrating an example in which the illumination light 101 emitted from the plurality of emitters included in the light source 11 is reflected by different reflectors to transmit the spatial optical signal in multiple directions. FIG. 6 is a view of the top plate 131 as viewed from a lower perspective. The transmission device 1 can simultaneously transmit a spatial optical signal (projection light 105, projection light 106) toward a communication target arranged in a plurality of directions by associating a plurality of modulation regions R set in the modulation part 120 with different reflectors.

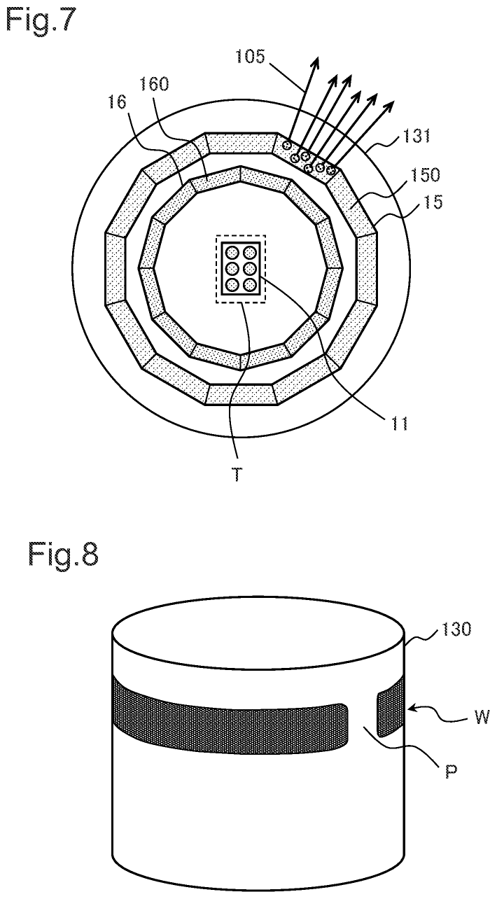

FIG. 7 is a conceptual diagram illustrating an example in which the modulation light 102 derived from the illumination light 101 emitted from the plurality of emitters included in the light source 11 is reflected by a single reflector to transmit the spatial optical signal in one direction. FIG. 7 is a view of the top plate 131 as viewed from a lower perspective. In the mode of searching for a communication target, the transmission device 1 can associate the plurality of modulation regions R set in the modulation part 120 with a single reflector, thereby transmitting spatial optical signals of a plurality of light fluxes toward the reflection direction of the reflecting surface of the reflector. Therefore, according to the transmission control as illustrated in FIG. 7, the detection speed of the communication target located in the reflection direction of the reflecting surface of the reflector is improved by transmitting the spatial optical signals of the plurality of light fluxes. The transmission device 1 may be controlled to transmit a multiplexed spatial optical signal (projection light 105, projection light 106) toward a single communication target. When transmitting the multiplexed spatial optical signal, the transmission device 1 sets the phase image in the modulation part 120 of the spatial light modulator 12 such that the modulation light 102 derived from the illumination light 101 is emitted to one point of the reflecting surface of the reflector.

The communication control unit 19 (communication control means) controls the light source 11 and the spatial light modulator 12. For example, the communication control unit 19 is achieved by a microcomputer including a processor and a memory. The communication control unit 19 sets a phase image relevant to the image to be projected in the modulation part 120. The communication control unit 19 sets a phase image relevant to the image to be projected in the modulation region set in the modulation part 120 of the spatial light modulator 12. The phase image of the projected image may be stored in advance in a storage unit (not illustrated). The shape and size of the image to be projected are not particularly limited.

The communication control unit 19 controls the spatial light modulator 12 such that a parameter that determines a difference between a phase of the illumination light 101 emitted to the modulation part 120 and a phase of the modulation light 102 reflected by the modulation part 120 changes. The method of driving the spatial light modulator 12 by the communication control unit 19 is determined according to the modulation scheme of the spatial light modulator 12. The communication control unit 19 drives the light source 11 in a state where the phase image relevant to the image to be displayed is set in the modulation part 120 of the spatial light modulator 12. As a result, with the phase image set in the modulation part 120, the modulation part 120 is irradiated with the illumination light 101 emitted from the light source 11. The illumination light 101 applied to the modulation part 120 is modulated by the modulation part 120.

The communication control unit 19 modulates the illumination light 101 emitted from the light source 11 for communication with a communication target (not illustrated). In communication, the communication control unit 19 controls the timing at which the illumination light 101 is emitted from the light source 11 in a state where the phase image for communication is set in the modulation part 120 of the spatial light modulator 12. By such control, the illumination light 101 is modulated. The modulation pattern of the illumination light 101 in the communication is arbitrarily set.

### [First Modification]

Next, a first modification of the present example embodiment will be described with reference to the drawings. The present modification is an example in which a pillar avoiding mirror for transmitting a spatial optical signal while avoiding a portion of a pillar of the housing 130 is arranged.

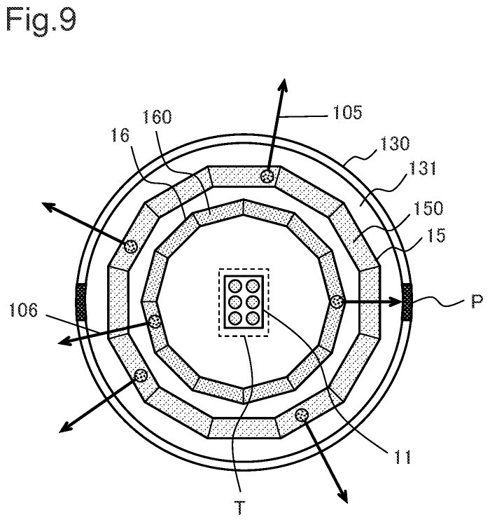

FIGS. 8 and 9 are conceptual diagrams for explaining a pillar P formed in a portion of the window W of the housing 130. FIG. 8 is a view of the housing 130 as viewed from an obliquely upper perspective. FIG. 9 is a view of the top plate 131 as viewed from a lower perspective. As illustrated in FIG. 9, a part of light reflected by the reflecting surface 150 of the first annular mirror array 15 or the reflecting surface 160 of the second annular mirror array 16 is shielded by the pillar P.

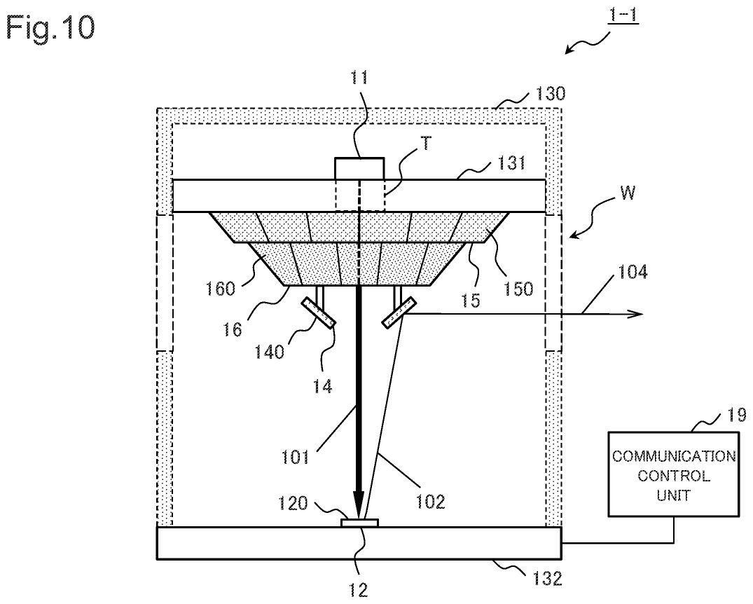

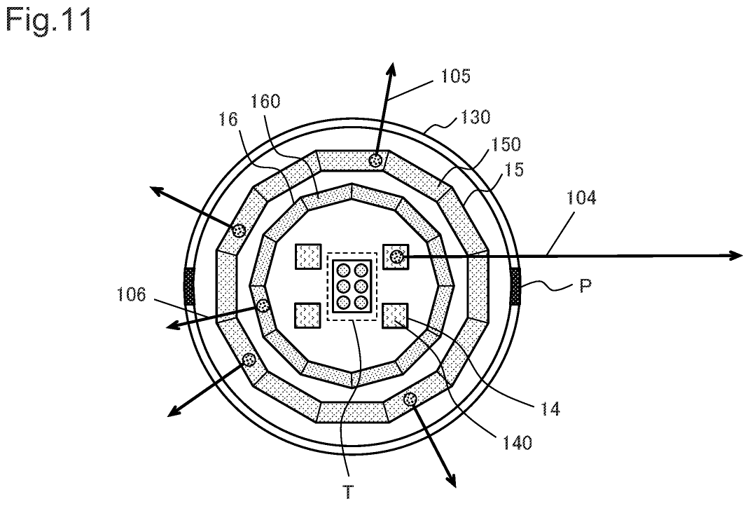

FIGS. 10 and 11 are conceptual diagrams for describing an example of a configuration (transmission device 1-1) of the present modification. In the present modification, a pillar avoiding mirror 14 for projecting a spatial optical signal (projection light 104) while avoiding the pillar P is arranged. FIG. 10 is a diagram of the internal configuration of the transmission device 1-1 to which the pillar avoiding mirror 14 is added as viewed from a side perspective. FIG. 10 illustrates the housing 130 cut at the portion of the window W. FIG. 11 is a view of the top plate 131 as viewed from a lower perspective.

The pillar avoiding mirror 14 is suspended from the top plate 131 inside the second annular mirror array 16. The reflecting surface 140 of the pillar avoiding mirror 14 is oriented in a direction avoiding the pillar P. In the examples of FIGS. 10 and 11, four pillar avoiding mirrors 14 are added. The number of pillar avoiding mirrors 14 is not limited to four. The pillar avoiding mirror 14 may be configured such that the projection light 104 is also projected in a direction going around the back side of the pillar P.

According to the present modification, by adding the pillar avoiding mirror 14, the spatial optical signal (projection light 104) can be projected also in the direction of the pillar P.

As described above, the transmission device of the present example embodiment includes the light source, the spatial light modulator, the first annular mirror array, the second annular mirror array, and the communication control unit. The light source, the spatial light modulator, the first annular mirror array, and the second annular mirror array constitute a transmitter. The light source emits the illumination light. The spatial light modulator includes a modulation part that emits illumination light emitted from a light source. The spatial light modulator emits the modulation light modulated by the modulation part toward at least one of the first annular mirror array and the second annular mirror array. The first annular mirror array includes a plurality of reflectors arranged in an annular shape around the optical axis of the illumination light. The second annular mirror array includes a plurality of reflectors arranged in an annular shape around the optical axis of the illumination light in a region inside the first annular mirror array in plan view. The plurality of reflectors constituting the first annular mirror array and the second annular mirror array are arranged such that the modulation light emitted from the spatial light modulator is reflected laterally. The reflecting surfaces of the plurality of reflectors constituting the second annular mirror array are oriented in a direction including a blind spot of one of the reflecting surfaces of the plurality of reflectors constituting the first annular mirror array. The communication control unit sets a phase image used for spatial light communication in a modulation part of the spatial light modulator. The communication control unit controls the light source so that the modulation part to which the phase image is set is irradiated with the illumination light.

The transmitter of the present example embodiment includes a first annular mirror array and a second annular mirror array configured by a plurality of reflectors. As the transmitter of the present example embodiment, a reflector having a large radius of curvature of the reflecting surface can be used as compared with a case where an annular mirror including one reflecting surface having a curvature in a horizontal plane is used. According to the transmitter of the present example embodiment, since the projection angle in the horizontal plane can be reduced, the spatial optical signal is hardly attenuated. According to the present example embodiment, by compensating the blind region of the first annular mirror array with the second annular mirror array, the spatial optical signal can be transmitted in an arbitrary direction along the horizontal plane. That is, according to the transmitter of the present example embodiment, a spatial optical signal that is hardly attenuated can be transmitted in an arbitrary direction along the horizontal plane.

In an aspect of the present example embodiment, the reflecting surfaces of the plurality of reflectors constituting the second annular mirror array are oriented in a direction including the boundaries of the plurality of reflectors constituting the first annular mirror array. According to the present aspect, the blind region generated at the boundary between the plurality of reflectors constituting the first annular mirror array can be compensated by the plurality of reflectors constituting the second annular mirror array. Therefore, according to the present aspect, a spatial optical signal that is hardly attenuated can be transmitted in an arbitrary direction along the horizontal plane.

A transmitter according to an aspect of the present example embodiment includes a pillar avoiding mirror. The pillar avoiding mirror is disposed at a position that reflects the modulation light while avoiding a pillar of a housing that houses the light source, the spatial light modulator, the first annular mirror array, and the second annular mirror array. According to the present aspect, the spatial optical signal can also be transmitted in the direction of the pillar of the housing by the pillar avoiding mirror that reflects the modulation light while avoiding the pillar of the housing.

In an aspect of the present example embodiment, the light source includes a plurality of emitters. The modulation part of the spatial light modulator is set with a plurality of modulation regions. Each of the plurality of emitters is associated with one of the plurality of modulation regions. In a mode of simultaneously communicating with a plurality of communication targets, the communication control unit controls the spatial light modulator such that the modulation light modulated in each of the plurality of modulation regions is emitted to the reflector associated with each of the plurality of communication targets among the reflectors constituting each of the first annular mirror array and the second annular mirror array. In the mode of searching for a communication target, the communication control unit controls the spatial light modulator so that a single reflector among the reflectors constituting each of the first annular mirror array and the second annular mirror array is irradiated with modulation light modulated in each of the plurality of modulation regions. According to the present aspect, the spatial light communication using spatial optical signals can be performed simultaneously with a plurality of communication targets. According to the present aspect, the multiplexed spatial optical signal can be transmitted to the single communication target.

### Second Example Embodiment

Next, a transmission device according to a second example embodiment will be described with reference to the drawings. A transmission device of the present example embodiment is different from the transmission device of the first example embodiment in including a relay mirror that returns modulation light modulated by a modulation part of a spatial light modulator.

### (Configuration)

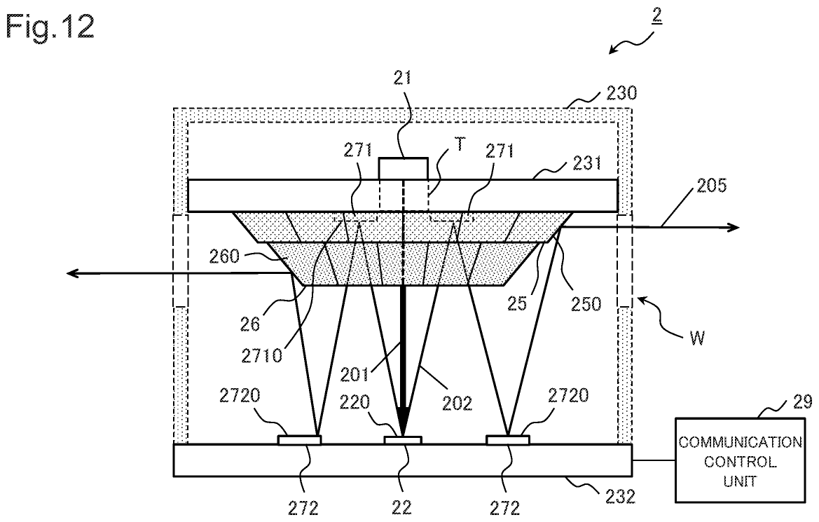

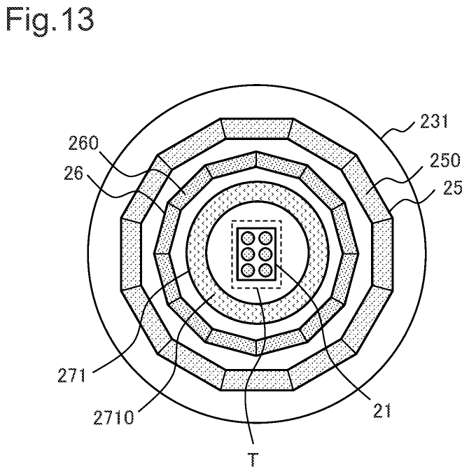

FIG. 12 is a conceptual diagram illustrating an example of a configuration of a transmission device 2 according to the present example embodiment. The transmission device 2 includes a light source 21, a spatial light modulator 22, a first annular relay mirror 271, a second annular relay mirror 272, a first annular mirror array 25, a second annular mirror array 26, and a communication control unit 29. The light source 21, the spatial light modulator 22, the first annular relay mirror 271, the second annular relay mirror 272, the first annular mirror array 25, and the second annular mirror array 26 constitute a transmitter. The transmitter is stored in a housing 230 in which a window W for transmitting a spatial optical signal is formed. FIG. 12 is a diagram of the internal configuration of the transmission device 2 housed in the housing 230 as viewed from a side perspective. FIG. 12 illustrates the housing 230 cut at the portion of the window W. FIG. 12 is conceptual, and does not accurately represent a shape of each component, a positional relationship between components, traveling of light, and the like. The configuration of FIG. 12 may be arranged in a state where the upper and lower sides are inverted.

FIG. 12 illustrates a top plate 231 that supports the light source 21, the first annular relay mirror 271, the first annular mirror array 25, and the second annular mirror array 26. The first annular relay mirror 271, the first annular mirror array 25, and the second annular mirror array 26 are disposed on the lower surface of the top plate 231. FIG. 12 illustrates the bottom plate 232 on which the spatial light modulator 22 and the second annular relay mirror 272 are disposed. The spatial light modulator 22 and the second annular relay mirror 272 are disposed on the upper surface of the bottom plate 232.

FIG. 13 is a conceptual diagram of the top plate 231 as viewed from a lower perspective. A through hole T is opened at the center of the top plate 231. The through hole T is an opening for allowing the illumination light 201 emitted from the light source 21 to pass downward. In the example of FIG. 13, the opening shape of the through hole Tis rectangular, but the opening shape of the through hole T may not be rectangular. The first annular relay mirror 271, the first annular mirror array 25, and the second annular mirror array 26 are arranged on the lower surface of the top plate 231. The first annular relay mirror 271 is an annular mirror. The first annular mirror array 25 and the second annular mirror array 26 are mirror arrays in which a plurality of reflectors are annularly arranged. The first annular relay mirror 271, the first annular mirror array 25, and the second annular mirror array 26 are arranged concentrically. The reflecting surfaces 250 of the plurality of reflectors constituting the first annular mirror array 25 and the reflecting surfaces 260 of the plurality of reflectors constituting the second annular mirror array 26 are both oriented in different directions.

The light source 21 has the same configuration as the light source 11 of the first example embodiment. The light source 21 emits the illumination light 201. An emission surface of the light source 21 is directed to the modulation part 220 of the spatial light modulator 22 via the through hole T of the top plate 231. The light source 21 may be disposed inside the through hole T. The light source 21 may be disposed on the lower surface of the top plate 231 or between the top plate 231 and the spatial light modulator 22. In this case, the through hole T may not be formed in the top plate 231. The illumination light 201 emitted from the light source 21 passes through the through hole T and is applied to the modulation part 220 of the spatial light modulator 22.

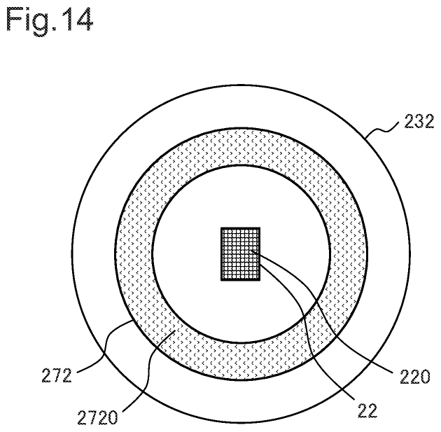

FIG. 14 is a conceptual diagram of the bottom plate 232 as viewed from an upper perspective. The spatial light modulator 22 is disposed at the center of the bottom plate 232. The second annular relay mirror 272 is disposed on the upper surface of the bottom plate 232. The second annular relay mirror 272 is an annular mirror. The spatial light modulator 22 has the same configuration as the spatial light modulator 12 of the first example embodiment. The spatial light modulator 22 is a phase modulation-type spatial light modulator. The spatial light modulator 22 includes a modulation part 220. A plurality of modulation regions are set in the modulation part 220.

A pattern (also referred to as a phase image) corresponding to the image displayed by projection light 205 or 206 is set in each of the plurality of modulation regions under the control of the communication control unit 29. Each of the plurality of modulation regions is irradiated with the illumination light 201 derived from the laser light emitted from the emitter associated with the modulation region. The illumination light 201 incident on each of the plurality of modulation regions set in the modulation part 220 is modulated according to the pattern (phase image) set in each of the plurality of modulation regions. The modulation light 202 modulated in each of the plurality of modulation regions travels toward a reflecting surface 2710 of first annular relay mirror 271.

The first annular relay mirror 271 is a reflector formed in an annular around shape around the center point of the top plate 231. The reflecting surface 2710 of the first annular relay mirror 271 faces the upper surface of the bottom plate 232 disposed below. The first annular relay mirror 271 is formed concentrically with the first annular mirror array 25 and the second annular mirror array 26. The first annular relay mirror 271 is disposed inside the first annular mirror array 25. The reflecting surface 2710 of the first annular relay mirror 271 is irradiated with the modulation light 202 modulated by the modulation part 220 of the spatial light modulator 22. The modulation light 202 applied to the reflecting surface 2710 of the first annular relay mirror 271 is reflected by the reflecting surface 2710 and travels toward a reflecting surface 2720 of the second annular relay mirror 272.

The second annular relay mirror 272 is a reflector formed in an annular shape around the center point of the bottom plate 232. The reflecting surface 2720 of the second annular relay mirror 272 faces the lower surface of the top plate 231 disposed above. The second annular relay mirror 272 is formed concentrically with the first annular relay mirror 271, the first annular mirror array 25, and the second annular mirror array 26 in plan view. The diameter of the second annular relay mirror 272 is larger than the diameter of the first annular relay mirror 271. The reflecting surface 2720 of the second annular relay mirror 272 is irradiated with the modulation light 202 reflected by the reflecting surface 2710 of the first annular relay mirror 271. The modulation light 202 applied to the reflecting surface 2720 of the second annular relay mirror 272 is reflected by the reflecting surface 2720 and travels toward the reflecting surface 250 of the first annular mirror array 25 or the reflecting surface 260 of the second annular mirror array 26.

The first annular mirror array 25 has the same configuration as the first annular mirror array 15 of the first example embodiment. The first annular mirror array 25 has a configuration in which a plurality of reflectors are arranged in an annular shape. Each of the plurality of reflectors is a reflector having a reflecting surface 250 having a curvature at least in the vertical direction. In the example of FIG. 13, the 12 reflectors constituting the first annular mirror array 25 are annularly arranged with their reflecting surfaces 250 facing obliquely downward. The number of reflectors constituting the first annular mirror array 25 is not limited to 12. The diameter of the annular ring formed by the first annular mirror array 25 is larger than the diameter of the annular ring formed by the second annular mirror array 26. The second annular mirror array 26 and the first annular relay mirror 271 are concentrically arranged inside the first annular mirror array 25.

The second annular mirror array 26 has the same configuration as the second annular mirror array 16 of the first example embodiment. The second annular mirror array 26 has a configuration in which a plurality of reflectors are arranged in an annular shape. Each of the plurality of reflectors is a reflector having a reflecting surface 260 having a curvature at least in the vertical direction. In the example of FIG. 13, the 12 reflectors constituting the second annular mirror array 26 are annularly arranged with their reflecting surfaces 260 facing obliquely downward. The number of reflectors constituting the second annular mirror array 26 is not limited to 12. In the example of FIG. 13, the number of reflectors constituting the second annular mirror array 26 is the same as the number of reflectors constituting the first annular mirror array 25. The number of reflectors constituting the second annular mirror array 26 may be different from the number of reflectors constituting the first annular mirror array 25. The size and shape of the reflector constituting the second annular mirror array 26 may be the same as or different from those of the reflector constituting the first annular mirror array 25. The diameter of the annular ring formed by the second annular mirror array 26 is smaller than the diameter of the annular ring formed by the first annular mirror array 25. The first annular mirror array 25 is concentrically arranged outside the second annular mirror array 26. The first annular relay mirror 271 is disposed concentrically inside the second annular mirror array 26.

The reflecting surface 250 of the reflector constituting the first annular mirror array 25 and the reflecting surface 260 of the reflector constituting the second annular mirror array 26 are oriented in different directions in the horizontal plane. In the example of FIG. 13, the reflecting surface 260 of the reflector constituting the second annular mirror array 26 is directed to the boundary of the reflector constituting the first annular mirror array 25. By combining the first annular mirror array 25 and the second annular mirror array 26 in this manner, the area of the blind region is reduced.

The modulation light 202 applied to the reflecting surface 250 of the first annular mirror array 25 is reflected by the reflecting surface 250. The light (projection light 205) reflected by the reflecting surface 250 is projected as a spatial optical signal. Similarly, the modulation light 202 applied to the reflecting surface 260 of the second annular mirror array 26 is reflected by the reflecting surface 260. The light (projection light 206) reflected by the reflecting surface 260 is projected as a spatial optical signal. The projection light 206 is also projected on a region including a blind region where the projection light 205 is not projected. The projection light 205 is also projected on a region including a blind region where the projection light 206 is not projected. That is, the projection light 205 and the projection light 206 reduce blind regions of each other.

The reflecting surface 250 of the first annular mirror array 25 and the reflecting surface 260 of the second annular mirror array 26 are oriented in an orientation of 360 degrees in the horizontal plane while compensating for each other's blind region. Therefore, by using the transmission device 2, the projection light 205 or 206 can be projected in a direction of 360 degrees in the horizontal plane by controlling the pattern (phase image) set in the modulation part 220 of the spatial light modulator 22.

The communication control unit 29 (communication control means) has the same configuration as the communication control unit 19 of the first example embodiment. The communication control unit 29 controls the light source 21 and the spatial light modulator 22. For example, the communication control unit 29 is achieved by a microcomputer including a processor and a memory. The communication control unit 29 sets a phase image relevant to the image to be projected in the modulation part 220. The communication control unit 29 sets a phase image relevant to the image to be projected in the modulation region set in the modulation part 220 of the spatial light modulator 22. The phase image of the projected image may be stored in advance in a storage unit (not illustrated). The shape and size of the image to be projected are not particularly limited.

The communication control unit 29 controls the spatial light modulator 22 such that a parameter that determines a difference between a phase of the illumination light 201 emitted to the modulation part 220 and a phase of the modulation light 202 reflected by the modulation part 220 changes. The method of driving the spatial light modulator 22 by the communication control unit 29 is determined according to the modulation scheme of the spatial light modulator 22. The communication control unit 29 drives the light source 21 in a state where the phase image relevant to the image to be displayed is set in the modulation part 220 of the spatial light modulator 22. As a result, with the phase image set in the modulation part 220, the modulation part 220 is irradiated with the illumination light 201 emitted from the light source 21. The illumination light 201 applied to the modulation part 220 is modulated by the modulation part 220.

The communication control unit 29 modulates the illumination light 201 emitted from the light source 21 for communication with a communication target (not illustrated). In communication, the communication control unit 29 controls the timing at which the illumination light 201 is emitted from the light source 21 in a state where the phase image for communication is set in the modulation part 220 of the spatial light modulator 22. By such control, the illumination light 201 is modulated. The modulation pattern of the illumination light 201 in the communication is arbitrarily set.

### [Second Modification]

Next, a second modification of the present example embodiment will be described with reference to the drawings. The present modification is a configuration example in which the number of relay mirrors is increased. In the present modification, the relay mirror will be mainly described, and description of other configurations will be omitted.

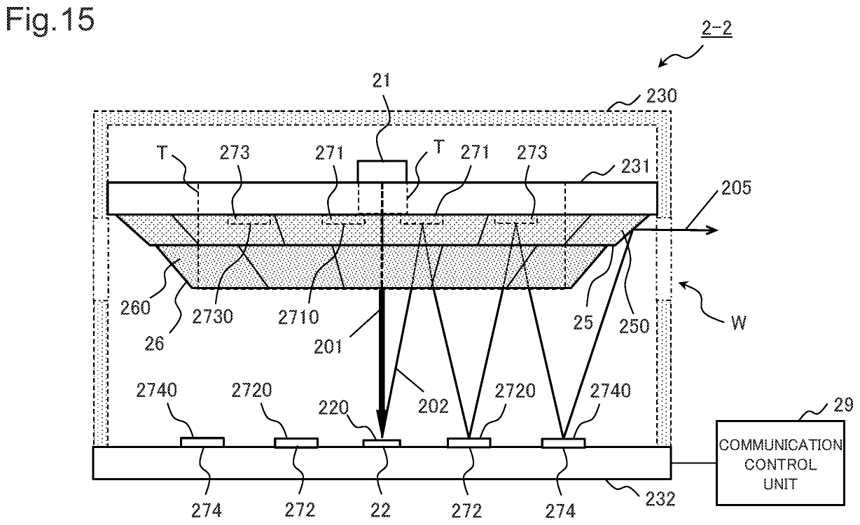

FIG. 15 is a conceptual diagram for explaining an example of a configuration (transmission device 2-2) of the present modification. In the present modification, a third annular relay mirror 273 and a fourth annular relay mirror 274 are disposed in addition to the first annular relay mirror 271 and the second annular relay mirror 272. FIG. 15 is a diagram of the internal configuration of the transmission device 2-2 to which the third annular relay mirror 273 and the fourth annular relay mirror 274 are added as viewed from a side perspective. FIG. 15 illustrates the housing 230 cut at the portion of the window W.

The first annular relay mirror 271 and the third annular relay mirror 273 are disposed on the lower surface of the top plate 231. The diameter of the third annular relay mirror 273 is larger than the diameter of the first annular relay mirror 271. The third annular relay mirror 273 is disposed outside the first annular relay mirror 271. The second annular mirror array 26 is disposed outside the third annular relay mirror 273. The first annular relay mirror 271, the third annular relay mirror 273, the first annular mirror array 25, and the second annular mirror array 26 are arranged concentrically around the center point of the top plate 231.

The second annular relay mirror 272 and the fourth annular relay mirror 274 are disposed on the upper surface of the bottom plate 232. The diameter of the fourth annular relay mirror 274 is larger than the diameter of the second annular relay mirror 272. The fourth annular relay mirror 274 is disposed outside the second annular relay mirror 272. The second annular relay mirror 272 and the fourth annular relay mirror 274 are arranged concentrically around the center point of the bottom plate 232.

The first annular relay mirror 271 is a reflector formed in an annular around shape around the center point of the top plate 231. The reflecting surface 2710 of the first annular relay mirror 271 faces the upper surface of the bottom plate 232 disposed below. The first annular relay mirror 271 is formed concentrically with the third annular relay mirror 273, the first annular mirror array 25, and the second annular mirror array 26. The first annular relay mirror 271 is disposed inside the third annular relay mirror 273. The reflecting surface 2710 of the first annular relay mirror 271 is irradiated with the modulation light 202 modulated by the modulation part 220 of the spatial light modulator 22. The modulation light 202 applied to the reflecting surface 2710 of the first annular relay mirror 271 is reflected by the reflecting surface 2710 and travels toward a reflecting surface 2720 of the second annular relay mirror 272.

The second annular relay mirror 272 is a reflector formed in an annular shape around the center point of the bottom plate 232. The reflecting surface 2720 of the second annular relay mirror 272 faces the lower surface of the top plate 231 disposed above. The second annular relay mirror 272 is formed concentrically with the fourth annular relay mirror 274. The diameter of the second annular relay mirror 272 is smaller than the diameter of the fourth annular relay mirror 274. The diameter of the second annular relay mirror 272 is larger than the diameter of the first annular relay mirror 271. The reflecting surface 2720 of the second annular relay mirror 272 is irradiated with the modulation light 202 reflected by the reflecting surface 2710 of the first annular relay mirror 271. The modulation light 202 applied to the reflecting surface 2720 of the second annular relay mirror 272 is reflected by the reflecting surface 2720 and travels toward a reflecting surface 2730 of the third annular relay mirror 273.

The third annular relay mirror 273 is a reflector formed in an annular shape around the center point of the top plate 231. The reflecting surface 2730 of the third annular relay mirror 273 faces the upper surface of the bottom plate 232 disposed below. The third annular relay mirror 273 is formed concentrically with the first annular relay mirror 271, the first annular mirror array 25, and the second annular mirror array 26. The third annular relay mirror 273 is disposed outside the first annular relay mirror 271. The reflecting surface 2730 of the third annular relay mirror 273 is irradiated with the modulation light 202 reflected by the reflecting surface 2720 of the second annular relay mirror 272. The modulation light 202 applied to the reflecting surface 2730 of the third annular relay mirror 273 is reflected by the reflecting surface 2730 and travels toward a reflecting surface 2740 of the fourth annular relay mirror 274.

The fourth annular relay mirror 274 is a reflector formed in an annular shape around the center point of the bottom plate 232. The reflecting surface 2740 of the fourth annular relay mirror 274 faces the lower surface of the top plate 231 disposed above. The fourth annular relay mirror 274 is formed concentrically with the second annular relay mirror 272. The diameter of the fourth annular relay mirror 274 is larger than the diameter of the second annular relay mirror 272. The diameter of the fourth annular relay mirror 274 is larger than the diameter of the third annular relay mirror 273. The reflecting surface 2740 of the fourth annular relay mirror 274 is irradiated with the modulation light 202 reflected by the reflecting surface 2730 of the third annular relay mirror 273. The modulation light 202 applied to the reflecting surface 2740 of the fourth annular relay mirror 274 is reflected by the reflecting surface 2740 and travels toward the reflecting surface 250 of the first annular mirror array 25 or the reflecting surface 260 of the second annular mirror array 26.

According to the present modification, by increasing the number of relay mirrors, the size and number of reflectors constituting the first annular mirror array 25 and the second annular mirror array 26 can be increased as compared with the transmission device 2. The transmission device 2-2 of the present modification can be made lower in height than the transmission device 2.

### [Third Modification]

Next, a third modification of the present example embodiment will be described with reference to the drawings. The present modification is a configuration example in which the positions of the light source 21 and the spatial light modulator 22 are interchanged.

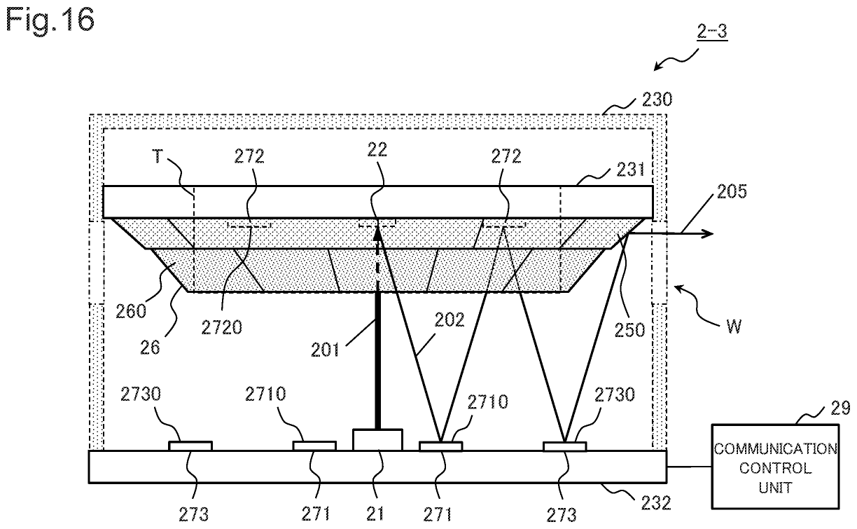

FIG. 16 is a conceptual diagram for explaining an example of a configuration (transmission device 2-3) of the present modification. In the present modification, the spatial light modulator 22 is disposed on the lower surface of the top plate 231, and the light source 21 is disposed on the upper surface of the bottom plate 232. FIG. 16 is a diagram of the internal configuration of the transmission device 2-3 of the present modification as viewed from a side perspective. FIG. 16 illustrates the housing 230 cut at the portion of the window W.

The light source 21 is disposed at the center of the upper surface of the bottom plate 232. The spatial light modulator 22 is disposed at the center of the top plate 231. The emission surface of the light source 21 and the modulation part 220 of the spatial light modulator 22 face each other. The first annular relay mirror 271 and the third annular relay mirror 273 are disposed on the upper surface of the bottom plate 232. The first annular relay mirror 271 and the third annular relay mirror 273 are arranged concentrically around the center point of the bottom plate 232. The first annular relay mirror 271 is disposed inside the third annular relay mirror 273. The second annular relay mirror 272 is disposed on the lower surface of the top plate 231. In plan view, the first annular relay mirror 271, the second annular relay mirror 272, and the third annular relay mirror 273 are concentrically arranged.

The illumination light 201 emitted from the light source 21 is irradiated to the modulation part 220 of the spatial light modulator 22. The illumination light 201 emitted to the modulation part 220 of the spatial light modulator 22 is modulated by the modulation part 220. The modulation light 202 modulated by the modulation part 220 travels toward the reflecting surface 2710 of the first annular relay mirror 271.

The modulation light 202 applied to the reflecting surface 2710 of the first annular relay mirror 271 is reflected by the reflecting surface 2710. The modulation light 202 reflected by the reflecting surface 2710 travels toward the reflecting surface 2720 of the second annular relay mirror 272. The modulation light 202 applied to the reflecting surface 2720 of the second annular relay mirror 272 is reflected by the reflecting surface 2720. The modulation light 202 reflected by the reflecting surface 2720 travels toward the reflecting surface 2730 of the third annular relay mirror 273. The modulation light 202 applied to the reflecting surface 2730 of the third annular relay mirror 273 is reflected by the reflecting surface 2730. The modulation light 202 reflected by the reflecting surface 2730 travels toward the reflecting surface 250 of the first annular mirror array 25 or the reflecting surface 260 of the second annular mirror array 26.

The modulation light 202 applied to the reflecting surface 250 of the first annular mirror array 25 is reflected by the reflecting surface 250 and transmitted as a spatial optical signal (projection light 205). The modulation light 202 applied to the reflecting surface 260 of the second annular mirror array 26 is reflected by the reflecting surface 260 and transmitted as a spatial optical signal (projection light 206).

According to the present modification, variations in the arrangement of the light source 21 and the spatial light modulator 22 are widened. If the light source 21 can be disposed on the side of the bottom plate 232, a higher output light source 21 can be used.

As described above, the transmission device of the present example embodiment includes the light source, the spatial light modulator, the at least two annular relay mirrors, the first annular mirror array, the second annular mirror array, and the communication control unit. The light source, the spatial light modulator, the first annular mirror array, and the second annular mirror array constitute a transmitter. The light source emits the illumination light. The spatial light modulator includes a modulation part that emits illumination light emitted from a light source. The spatial light modulator emits the modulation light modulated by the modulation part toward the reflecting surface of one of the annular relay mirrors. The at least two annular relay mirrors are formed in an annular shape around the optical axis of the illumination light. The at least two annular relay mirrors relay and reflect the modulation light emitted from the spatial light modulator toward at least one of the first annular mirror array and the second annular mirror array. The first annular mirror array includes a plurality of reflectors arranged in an annular shape around the optical axis of the illumination light. The second annular mirror array includes a plurality of reflectors arranged in an annular shape around the optical axis of the illumination light in a region inside the first annular mirror array in plan view. The plurality of reflectors constituting the first annular mirror array and the second annular mirror array are arranged such that the modulation light emitted from the spatial light modulator is reflected laterally. The reflecting surfaces of the plurality of reflectors constituting the second annular mirror array are oriented in a direction including a blind region of one of the reflecting surfaces of the plurality of reflectors constituting the first annular mirror array. The communication control unit sets a phase image used for spatial light communication in a modulation part of the spatial light modulator. The communication control unit controls the light source so that the modulation part to which the phase image is set is irradiated with the illumination light.

In the configuration of the present example embodiment, the modulation light modulated by the modulation part of the spatial light modulator travels toward the reflecting surface of at least one of the first annular mirror array and the second annular mirror array via the reflecting surface of the annular relay mirror. According to the configuration of the present example embodiment, the modulation light is folded back and reflected by the annular relay mirror, so that the interval between the spatial light modulator and the reflector can be reduced. Therefore, according to the present example embodiment, the transmitter can be thinned.

A transmitter according to an aspect of the present example embodiment includes a first annular relay mirror and a second annular relay mirror. The first annular relay mirror is formed in an annular shape around the optical axis of the illumination light. The first annular relay mirror is disposed on an optical path of the modulation light modulated by the spatial light modulator. The first annular relay mirror reflects the modulation light with which the reflecting surface is irradiated toward the reflecting surface of the second annular relay mirror. The second annular relay mirror is formed in an annular shape around the optical axis of the illumination light in a region outside the first annular relay mirror in plan view. The second annular relay mirror is disposed on the optical path of the modulation light reflected by the reflecting surface of the first annular relay mirror. The second annular relay mirror reflects the modulation light with which the reflecting surface is irradiated toward at least one of the first annular mirror array and the second annular mirror array. According to the present aspect, the space between the spatial light modulator and the reflector can be reduced by returning and reflecting the modulation light by the first annular relay mirror and the second annular relay mirror. Therefore, according to the present example embodiment, the transmitter can be thinned.

### Third Example Embodiment

Next, a transmission device according to a third example embodiment will be described with reference to the drawings. A transmission device of the present example embodiment is different from the transmission devices of the first and second example embodiments in that the transmission device includes a photodetector that monitors power of a spatial optical signal.

### (Configuration)

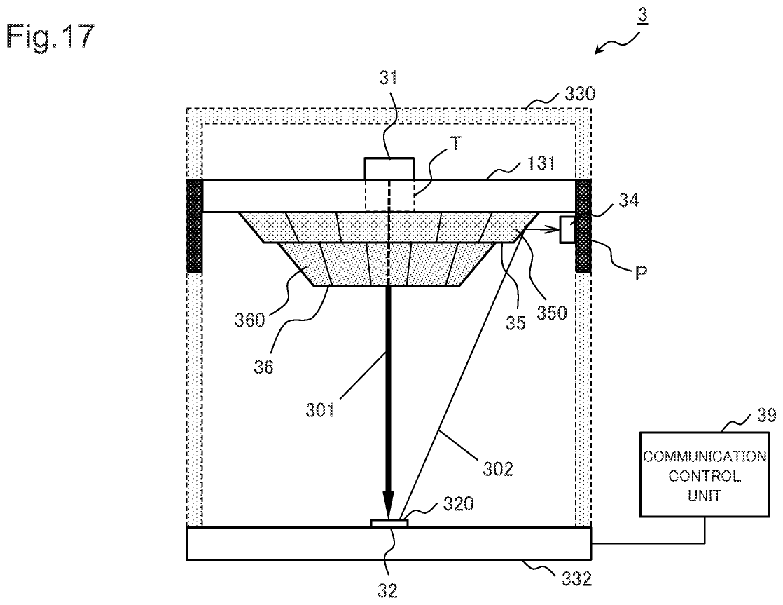

FIG. 17 is a conceptual diagram illustrating an example of a configuration of a transmission device 3 according to the present example embodiment. The transmission device 3 includes a light source 31, a spatial light modulator 32, a photodetector 34, a first annular mirror array 35, a second annular mirror array 36, and a communication control unit 39. The light source 31, the spatial light modulator 32, the photodetector 34, the first annular mirror array 35, and the second annular mirror array 36 constitute a transmitter. The transmitter is stored in a housing 330 in which a window W for transmitting a spatial optical signal is formed. FIG. 17 is a diagram of the internal configuration of the transmission device 3 housed in the housing 330 as viewed from a side perspective. FIG. 17 illustrates the housing 330 cut at a portion of the pillar P without the window W. In FIG. 17, the portion of the pillar P is exaggerated. FIG. 17 is conceptual, and does not accurately represent a shape of each component, a positional relationship between components, traveling of light, and the like. The configuration of FIG. 17 may be arranged in a state where the upper and lower sides are inverted.

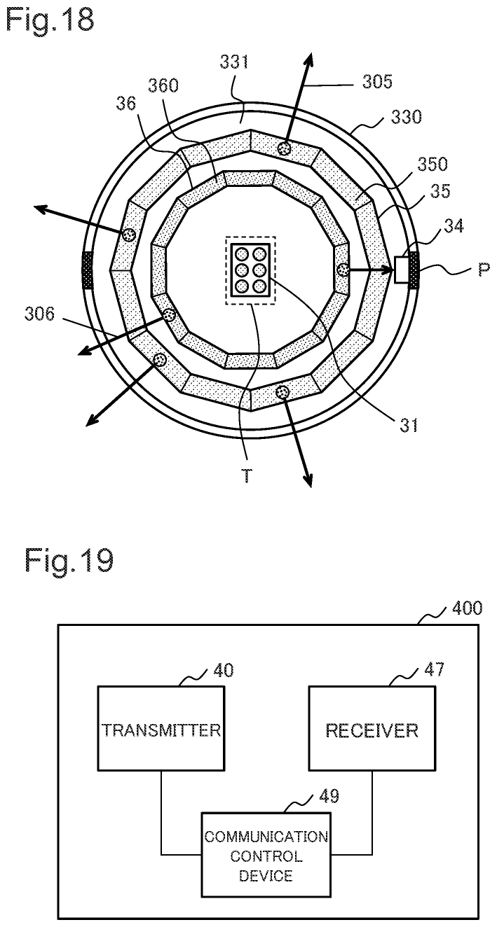

FIG. 18 is a cross-sectional view of the housing 330 taken along a section passing through the portion of the pillar P. FIG. 18 is a conceptual diagram of a top plate 331 as viewed from a lower perspective. FIG. 18 illustrates the light source 31, the first annular mirror array 35, and the second annular mirror array 36 disposed on the lower surface of the top plate 331. A through hole T is opened at the center of the top plate 331. The through hole T is an opening for allowing the illumination light 301 emitted from the light source 31 to pass downward. FIG. 18 illustrates the photodetector 34 disposed in a portion of the pillar P.

The light source 31 has the same configuration as the light source 11 of the first example embodiment. The light source 31 emits the illumination light 301. An emission surface of the light source 31 is directed to a modulation part 320 of the spatial light modulator 32 via the through hole T of the top plate 331. The light source 31 may be disposed inside the through hole T. The light source 31 may be disposed on the lower surface of the top plate 331 or between the top plate 331 and the spatial light modulator 32. In this case, the through hole T may not be formed in the top plate 331. The illumination light 301 emitted from the light source 31 passes through the through hole T and is applied to the modulation part 320 of the spatial light modulator 32.

The spatial light modulator 32 has the same configuration as the spatial light modulator 12 of the first example embodiment. The spatial light modulator 32 is a phase modulation-type spatial light modulator. The spatial light modulator 32 includes a modulation part 320. A plurality of modulation regions are set in the modulation part 320.

A pattern (also referred to as a phase image) corresponding to the image displayed by projection light 305 or 306 is set in each of the plurality of modulation regions under the control of the communication control unit 39. Each of the plurality of modulation regions is irradiated with the illumination light 301 derived from the laser light emitted from the emitter associated with the modulation region. The illumination light 301 incident on each of the plurality of modulation regions set in the modulation part 320 is modulated according to the pattern (phase image) set in each of the plurality of modulation regions. The modulation light 302 modulated in each of the plurality of modulation regions travels toward the reflecting surface 350 of the first annular mirror array 35, the reflecting surface 360 of the second annular mirror array 36, or the photodetector 34.

The first annular mirror array 35 has the same configuration as the first annular mirror array 15 of the first example embodiment. The first annular mirror array 35 has a configuration in which a plurality of reflectors are arranged in an annular shape. Each of the plurality of reflectors is a reflector having a reflecting surface 350 having a curvature at least in the vertical direction. In the example of FIG. 18, the 12 reflectors constituting the first annular mirror array 35 are annularly arranged with their reflecting surfaces 350 facing obliquely downward. The number of reflectors constituting the first annular mirror array 35 is not limited to 12. The diameter of the annular ring formed by the first annular mirror array 35 is larger than the diameter of the annular ring formed by the second annular mirror array 36. The second annular mirror array 36 is concentrically arranged inside the first annular mirror array 35.

The second annular mirror array 36 has the same configuration as the second annular mirror array 16 of the first example embodiment. The second annular mirror array 36 has a configuration in which a plurality of reflectors are arranged in an annular shape. Each of the plurality of reflectors is a reflector having a reflecting surface 360 having a curvature at least in the vertical direction. In the example of FIG. 18, the 12 reflectors constituting the second annular mirror array 36 are annularly arranged with their reflecting surfaces 360 facing obliquely downward. The number of reflectors constituting the second annular mirror array 36 is not limited to 12. In the example of FIG. 18, the number of reflectors constituting the second annular mirror array 36 is the same as the number of reflectors constituting the first annular mirror array 35. The number of reflectors constituting the second annular mirror array 36 may be different from the number of reflectors constituting the first annular mirror array 35. The size and shape of the reflector constituting the second annular mirror array 36 may be the same as or different from those of the reflector constituting the first annular mirror array 35. The diameter of the annular ring formed by the second annular mirror array 36 is smaller than the diameter of the annular ring formed by the first annular mirror array 35. The first annular mirror array 35 is concentrically arranged outside the second annular mirror array 36.

The reflecting surface 350 of the reflector constituting the first annular mirror array 35 and the reflecting surface 360 of the reflector constituting the second annular mirror array 36 are oriented in different directions in the horizontal plane. In the example of FIG. 18, the reflecting surface 360 of the reflector constituting the second annular mirror array 36 is directed to the boundary of the reflector constituting the first annular mirror array 35. By combining the first annular mirror array 35 and the second annular mirror array 36 in this manner, the area of the blind region is reduced.

The modulation light 302 applied to the reflecting surface 350 of the first annular mirror array 35 is reflected by the reflecting surface 350. The light (projection light 305) reflected by the reflecting surface 350 is projected as a spatial optical signal. Similarly, the modulation light 302 applied to the reflecting surface 360 of the second annular mirror array 36 is reflected by the reflecting surface 360. The light (projection light 306) reflected by the reflecting surface 360 is projected as a spatial optical signal. The projection light 306 is also projected on a region including a blind region where the projection light 305 is not projected. The projection light 305 is also projected on a region including a blind region where the projection light 306 is not projected. That is, the projection light 305 and the projection light 306 reduce blind regions of each other.

The reflecting surface 350 of the first annular mirror array 35 and the reflecting surface 360 of the second annular mirror array 36 are oriented in an orientation of 360 degrees in the horizontal plane while compensating for each other's blind region. Therefore, by using the transmission device 3, the projection light 305 or 306 can be projected in a direction of 360 degrees in the horizontal plane by controlling the pattern (phase image) set in the modulation part 320 of the spatial light modulator 32

In the optical power measuring mode, the photodetector 34 is irradiated with the modulation light 302. The photodetector 34 converts the emitted modulation light 302 into an electrical signal. The electrical signal converted by the photodetector 34 is output to the communication control unit 39. The communication control unit 39 measures optical power of the modulation light 302 based on the electrical signal output from the photodetector 34.

The photodetector 34 is a light receiving element that receives light in a wavelength region of the modulation light 302 to be measured for optical power. For example, the photodetector 34 has sensitivity to light in the visible region. For example, the photodetector 34 has sensitivity to light in the infrared region. The photodetector 34 has sensitivity to light having a wavelength in a 1.5 μm (micrometer) band, for example. The wavelength band of light with which the photodetector 34 has sensitivity is not limited to the 1.5 μm band. The wavelength band of the light received by the photodetector 34 can be set in accordance with the wavelength of the spatial optical signal to be received. The wavelength band of the light received by the photodetector 34 may be set to, for example, a 0.8 μm band, a 1.55 μm band, or a 2.2 μm band. The wavelength band of the light received by the photodetector 34 may be, for example, a 0.8 to 1 μm band.

For example, the photodetector 34 can be achieved by an element such as a photodiode or a phototransistor. For example, the photodetector 34 is achieved by an avalanche photodiode. The photodetector 34 may be achieved by an element other than a photodiode, a phototransistor, or an avalanche photodiode as long as an optical signal can be converted into an electrical signal.

The communication control unit 39 controls the light source 31 and the spatial light modulator 32. For example, the communication control unit 39 is achieved by a microcomputer including a processor and a memory. The communication control unit 39 sets a phase image relevant to the image to be projected in the modulation part 320. The communication control unit 39 sets a phase image relevant to the image to be projected in the modulation region set in the modulation part 320 of the spatial light modulator 32. The phase image of the projected image may be stored in advance in a storage unit (not illustrated). The shape and size of the image to be projected are not particularly limited.

The communication control unit 39 controls the spatial light modulator 32 such that a parameter that determines a difference between a phase of the illumination light 301 emitted to the modulation part 320 and a phase of the modulation light 302 reflected by the modulation part 320 changes. The method of driving the spatial light modulator 32 by the communication control unit 39 is determined according to the modulation scheme of the spatial light modulator 32. The communication control unit 39 drives the light source 31 in a state where the phase image relevant to the image to be displayed is set in the modulation part 320 of the spatial light modulator 32. As a result, with the phase image set in the modulation part 320, the modulation part 320 is irradiated with the illumination light 301 emitted from the light source 31. The illumination light 301 applied to the modulation part 320 is modulated by the modulation part 320.

The communication control unit 39 modulates the illumination light 301 emitted from the light source 31 for communication with a communication target (not illustrated). In communication, the communication control unit 39 controls the timing at which the illumination light 301 is emitted from the light source 31 in a state where the phase image for communication is set in the modulation part 320 of the spatial light modulator 32. By such control, the illumination light 301 is modulated. The modulation pattern of the illumination light 301 in the communication is arbitrarily set.

Further, the communication control unit 39 shifts to an optical power measuring mode of actually measuring the light intensity of the spatial optical signal (projection light 305, projection light 306). In the optical power measuring mode, the communication control unit 39 sets a pattern (phase image) for emitting the modulation light 302 toward the photodetector 34 in the modulation part 320 of the spatial light modulator 32. The communication control unit 39 measures the optical power of the modulation light 302 using the electrical signal output from the photodetector 34 in response to the irradiation of the modulation light 302. The communication control unit 39 adjusts the output of the light source 31 according to the measured optical power. For example, the communication control unit 39 adjusts the output of the light source 31 so as to fall within a preset output range. An output range of the light source 31 is not particularly limited. For example, the output range of the light source 31 is set in accordance with legal standards.

As described above, the transmission device of the present example embodiment includes the light source, the spatial light modulator, the first annular mirror array, the second annular mirror array, the photodetector, and the communication control unit. The light source, the spatial light modulator, the first annular mirror array, and the second annular mirror array constitute a transmitter. The light source emits the illumination light. The spatial light modulator includes a modulation part that emits illumination light emitted from a light source. The spatial light modulator emits the modulation light modulated by the modulation part toward at least one of the first annular mirror array and the second annular mirror array. The first annular mirror array includes a plurality of reflectors arranged in an annular shape around the optical axis of the illumination light. The second annular mirror array includes a plurality of reflectors arranged in an annular shape around the optical axis of the illumination light in a region inside the first annular mirror array in plan view. The plurality of reflectors constituting the first annular mirror array and the second annular mirror array are arranged such that the modulation light emitted from the spatial light modulator is reflected laterally. The reflecting surfaces of the plurality of reflectors constituting the second annular mirror array are oriented in a direction including a blind region of one of the reflecting surfaces of the plurality of reflectors constituting the first annular mirror array. For example, the photodetector is disposed inside a pillar of the housing. The photodetector detects modulation light reflected by one of the reflectors of the first annular mirror array and the second annular mirror array. The communication control unit sets a phase image used for spatial light communication in a modulation part of the spatial light modulator. The communication control unit controls the light source so that the modulation part to which the phase image is set is irradiated with the illumination light. In the optical power measuring mode, the communication control unit controls the spatial light modulator so as to irradiate the photodetector with the modulation light modulated by the spatial light modulator. The communication control unit measures optical power of the modulation light detected by the photodetector. The communication control unit adjusts the output of the light source according to the measured optical power of the modulation light.

The transmission device of the present example embodiment can directly measure the optical power of the spatial optical signal (projection light) using the photodetector. Therefore, according to the present aspect, the output of the light source can be adjusted according to the measured optical power of the spatial optical signal.

### Fourth Example Embodiment

Next, a communication device according to a fourth example embodiment will be described with reference to the drawings. The communication device of the present example embodiment has a configuration in which a transmission device and a reception device are combined. The transmission device has a configuration of any one of the first to third example embodiments. The reception device is not particularly limited as long as it can receive the spatial optical signal. Hereinafter, an example of a reception device having a light receiving function including a ball lens will be described. The communication device of the present example embodiment may include a reception device having another light receiving function instead of the light receiving function including the ball lens.

FIG. 19 is a conceptual diagram illustrating an example of a configuration of a communication device 400 according to the present example embodiment. The communication device 400 includes a transmitter 40, a receiver 47, and a communication control device 49. The communication device 400 transmits and receives spatial optical signals to and from an external communication target. Therefore, an opening or a window for transmitting and receiving a spatial optical signal is formed in the communication device 400.

The transmitter 40 is a transmitter included in any of the transmission devices of the first to third example embodiments. The transmitter 40 acquires a control signal from the communication control device 49. The transmitter 40 projects a spatial optical signal according to the control signal. The spatial optical signal projected from the transmitter 40 is received by a communication target (not illustrated) of a transmission destination of the spatial optical signal.

The receiver 47 receives a spatial optical signal transmitted from a communication target (not illustrated). The receiver 47 converts the received spatial optical signal into an electrical signal. The receiver 47 outputs the converted electrical signal to the communication control device 49. For example, the receiver 47 has a light receiving function including a ball lens. The receiver 47 may have a light receiving function that does not include a ball lens.

The communication control device 49 acquires a signal output from the receiver 47. The communication control device 49 executes processing according to the acquired signal. The processing executed by the communication control device 49 is not particularly limited. The communication control device 49 outputs a control signal for transmitting an optical signal corresponding to the executed processing to the transmitter 40. For example, the communication control device 49 executes processing based on a predetermined condition according to information included in the signal received by the receiver 47. For example, the communication control device 49 executes processing designated by an administrator of the communication device 400 according to information included in the signal received by the receiver 47.

### [Receiver]

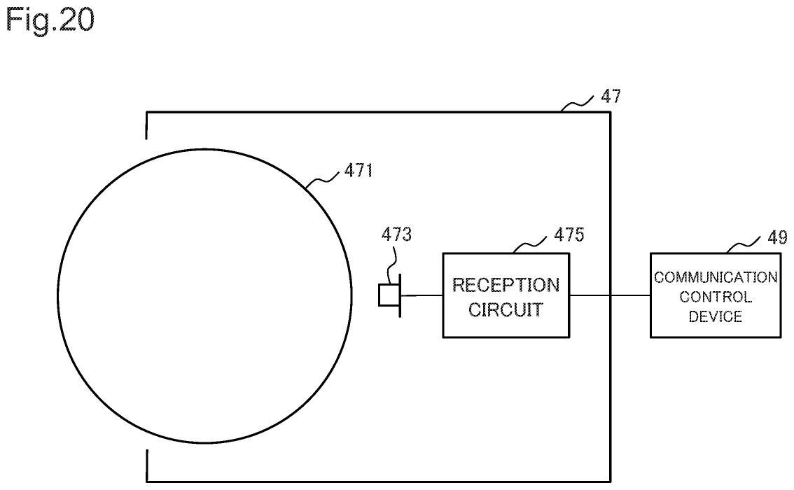

Next, a configuration of the receiver 47 will be described with reference to the drawings. FIG. 20 is a conceptual diagram for explaining an example of a configuration of the receiver 47. The receiver 47 includes a ball lens 471, a light receiving element 473, and a reception circuit 475. FIG. 20 is a side view of the internal configuration of the receiver 47 as viewed from a side perspective. The position of the reception circuit 475 is not particularly limited. The reception circuit 475 may be disposed inside the receiver 47 or may be disposed outside the receiver 47. The function of the reception circuit 475 may be included in the communication control device 49.

The ball lens 471 is a spherical lens. The ball lens 471 is an optical element that collects a spatial optical signal transmitted from a communication target. The ball lens 471 has a spherical shape when viewed from any angle. A part of the ball lens 471 protrudes from an opening opened in a housing of the receiver 47. The ball lens 471 collects the incident spatial optical signal. The spatial optical signal incident on the ball lens 471 protruding from the opening is collected. As long as the spatial optical signal can be condensed, a part of the ball lens 471 may not protrude from the opening.

Light (optical signal) derived from the spatial optical signal condensed by the ball lens 471 is condensed toward the condensing region of the ball lens 471. Since the ball lens 471 has a spherical shape, the ball lens collects a spatial optical signal arriving from any direction. That is, the ball lens 471 exhibits similar light condensing performance for a spatial optical signal arriving from any direction. The light incident on the ball lens 471 is refracted when entering the inside of the ball lens 471. The light traveling inside the ball lens 471 is refracted again when being emitted to the outside of the ball lens 471. Most of the light emitted from the ball lens 471 is condensed in the condensing region.

For example, the ball lens 471 can be made of a material such as glass, crystal, or resin. In the case of receiving a spatial optical signal in the visible region, the ball lens 471 can be achieved by a material such as glass, crystal, or resin that transmits/refracts light in the visible region. For example, the ball lens 471 can be achieved by optical glass such as crown glass or flint glass. For example, the ball lens 471 can be achieved by a crown glass such as BK (Boron Kron). For example, the ball lens 471 can be achieved by a flint glass such as Lanthanum Schwerflint (LaSF). For example, quartz glass can be applied to the ball lens 471. For example, a crystal such as sapphire can be applied to the ball lens 471. For example, a transparent resin such as acrylic can be applied to the ball lens 471.

In a case where the spatial optical signal is light in a near-infrared region (hereinafter, near-infrared ray), a material that transmits near-infrared rays is used for the ball lens 471. For example, in a case of receiving a spatial optical signal in a near-infrared region of about 1.5 micrometers (μm), a material such as silicon can be applied to the ball lens 471 in addition to glass, crystal, resin, and the like. In a case where the spatial optical signal is light in an infrared region (hereinafter, infrared rays), a material that transmits infrared rays is used for the ball lens 471. For example, in a case where the spatial optical signal is an infrared ray, silicon, germanium, or a chalcogenide material can be applied to the ball lens 471. The material of the ball lens 471 is not limited as long as light in the wavelength region of the spatial optical signal can be transmitted/refracted. The material of the ball lens 471 may be appropriately selected according to the required refractive index and use.

The ball lens 471 may be replaced with another concentrator as long as the spatial optical signal can be condensed toward the region where the light receiving element 473 is disposed. For example, the ball lens 471 may be a light beam control element that guides the incident spatial optical signal toward the light receiving unit of the light receiving element 473. For example, the ball lens 471 may have a configuration in which a lens or a light beam control element is combined. For example, a mechanism that guides the optical signal condensed by the ball lens 471 toward the light receiving unit of the light receiving element 473 may be added.

The light receiving element 473 is disposed at a subsequent stage of the ball lens 471. The light receiving element 473 is disposed in the condensing region of the ball lens 471. The light receiving element 473 includes a light receiving unit that receives the optical signal collected by the ball lens 471. The optical signal collected by the ball lens 471 is received by the light receiving unit of the light receiving element 473. The light receiving element 473 converts the received optical signal into an electrical signal (hereinafter, signal). The light receiving element 473 outputs the converted signal to the reception circuit 475. FIG. 25 illustrates an example in which the light receiving element 473 is a single element. For example, the plurality of light receiving elements 473 may be arranged in the condensing region of the ball lens 471. For example, a light receiving element array in which a plurality of light receiving elements 473 are arrayed may be disposed in the condensing region of the ball lens 471.

The light receiving element 473 receives light in a wavelength region of the spatial optical signal to be received. For example, the light receiving element 473 has sensitivity to light in the visible region. For example, the light receiving element 473 has sensitivity to light in an infrared region. The light receiving element 473 has sensitivity to light having a wavelength in a 1.5 μm (micrometer) band, for example. The wavelength band of light with which the light receiving element 473 has sensitivity is not limited to the 1.5 μm band. The wavelength band of the light received by the light receiving element 473 can be set in accordance with the wavelength of the spatial optical signal to be received. The wavelength band of the light received by the light receiving element 473 may be set to, for example, a 0.8 μm band, a 1.55 μm band, or a 2.2 μm band. The wavelength band of the light received by the light receiving element 473 may be, for example, a 0.8 to 1 μm band. A shorter wavelength band is advantageous for optical spatial communication during rainfall because absorption by moisture in the atmosphere is small. If the light receiving element 473 is saturated with intense sunlight, the light receiving element cannot read the optical signal derived from the spatial optical signal. Therefore, a color filter that selectively passes the light of the wavelength band of the spatial optical signal may be installed at the preceding stage of the light receiving element 473.

For example, the light receiving element 473 can be achieved by an element such as a photodiode or a phototransistor. For example, the light receiving element 473 is achieved by an avalanche photodiode. The light receiving element 473 implemented by the avalanche photodiode can support high-speed communication. The light receiving element 473 may be achieved by an element other than a photodiode, a phototransistor, or an avalanche photodiode as long as an optical signal can be converted into an electrical signal. In order to improve the communication speed, the light receiving unit of the light receiving element 473 may be as small as possible. For example, the light receiving unit of the light receiving element 473 has a square light receiving surface having a side of about 5 mm (mm). For example, the light receiving unit of the light receiving element 473 has an annular light receiving surface having a diameter of about 0.1 to 0.3 mm. The size and shape of the light receiving unit of the light receiving element 473 may be selected according to the wavelength band, the communication speed, and the like of the spatial optical signal.

For example, a polarizing filter (not illustrated) may be disposed in the preceding stage of the light receiving element 473. The polarizing filter is disposed in association with the light receiving unit of the light receiving element 473. For example, the polarizing filter is disposed to overlap the light receiving unit of the light receiving element 473. For example, the polarizing filter may be selected according to the polarization state of the spatial optical signal to be received. For example, when the spatial optical signal to be received is linearly polarized light, the polarizing filter includes a ½ wave plate. For example, when the spatial optical signal to be received is annularly polarized light, the polarizing filter includes a ¼ wave plate. The polarization state of the optical signal having passed through the polarizing filter is converted according to the polarization characteristic of the polarizing filter.

The reception circuit 475 acquires a signal output from the light receiving element 473. The reception circuit 475 amplifies the signal from the light receiving element 473. The reception circuit 475 decodes the amplified signal. The signal decoded by the reception circuit 475 is used for any purpose. The use of the signal decoded by the reception circuit 475 is not particularly limited.

### [Communication Device]

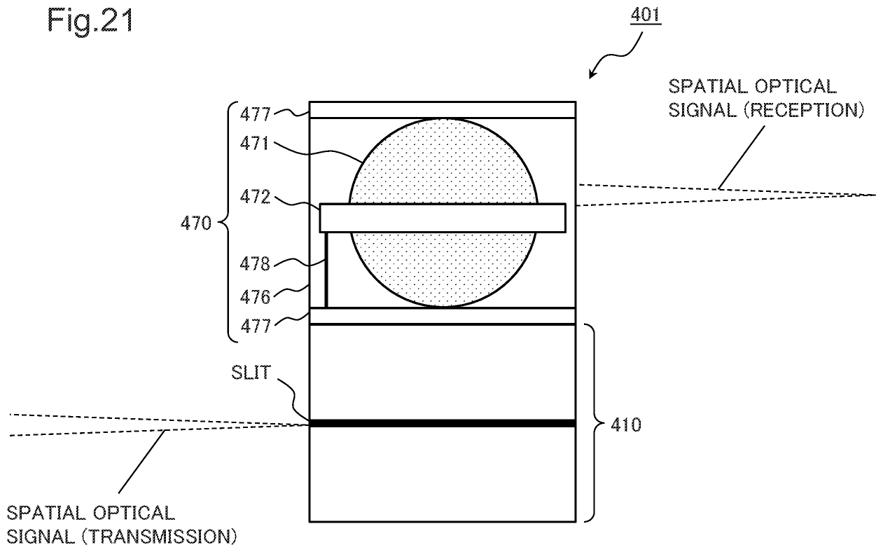

FIG. 21 is a conceptual diagram illustrating an example (communication device 401) of the communication device 400. The communication device 401 includes a transmitter 410, a receiver 470, and a communication control device (not illustrated). In FIG. 21, a reception circuit and a communication control device are omitted. The reception circuit and the communication control device are disposed inside the communication device 401. The communication device 401 has a configuration in which the transmitter 410 having a cylindrical outer shape and the receiver 470 are combined.

The receiver 470 includes a ball lens 471, a light receiver 472, a color filter 476, and a support element 477. The upper and lower portions of the ball lens 471 are sandwiched between a pair of support elements 477 arranged vertically. Since the upper and lower sides of the ball lens 471 are not used for transmission and reception of spatial optical signals, they may be processed into a planar shape so as to be easily sandwiched by the support element 477. The light receiver 472 is arranged in accordance with the condensing region of the ball lens 471 so as to be able to receive the spatial optical signal to be received. The light receiver 472 includes a light receiving element array in which a plurality of light receiving elements are annularly arranged. The plurality of light receiving elements are arranged in the condensing region of the ball lens 471. The plurality of light receiving elements are arranged with the light receiving unit facing the ball lens 471. The plurality of light receiving elements are connected to the communication control device or the transmitter 410 by a conductive wire 478.

The color filter 476 is disposed on a side surface of the cylindrical receiver 470. The color filter 476 removes unnecessary light and selectively transmits a spatial optical signal used for communication. A pair of support elements 477 is disposed on upper and lower surfaces of the cylindrical receiver 470. The pair of support elements 477 sandwich the ball lens 471 from above and below. The light receiver 472 formed in an annular shape is disposed around the ball lens 471. The light receiver 472 includes a plurality of light receiving elements, which face the light receiving unit, in the ball lens 471. The spatial optical signal incident on the ball lens 471 through the color filter 476 is condensed toward the light receiver 472 by the ball lens 471. The optical signal condensed on the light receiver 472 is guided toward the light receiving unit of one of the light receiving elements. The optical signal reaching the light receiving unit of the light receiving element is received by the light receiving element. A communication control device (not illustrated) decodes an optical signal received by a light receiving element included in the light receiver 472. The communication control device causes the transmitter 410 to transmit the spatial optical signal according to the decoded optical signal.

The transmitter 410 includes a transmitter included in any of the transmission devices of the first to third example embodiments. The transmitter 410 is housed inside a cylindrical housing. A slit opened in accordance with the transmission direction of the spatial optical signal by the transmitter 410 is formed in the cylindrical housing. For example, in a case where the transmitter 410 can transmit the spatial optical signal in the direction of 360 degrees, a slit is formed on the side surface of the housing of the transmitter 410 in accordance with the transmission direction of the spatial optical signal.

### [Application Example]

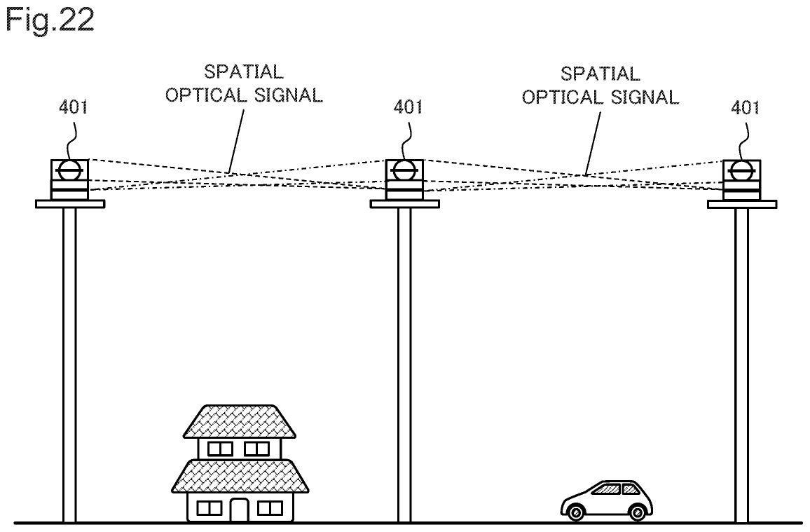

Next, an application example of the present example embodiment will be described with reference to the drawings. In the following application example, an example in which a plurality of communication devices 401 transmit and receive spatial optical signals will be described. FIG. 22 is a conceptual diagram for explaining the present application. In the present application example, an example (communication system) of a communication network in which a plurality of communication devices 401 are disposed on an upper portion (space above a pole) of a pole such as a utility pole or a street lamp disposed in a town will be described.

There are few obstacles in the space above the pole. Therefore, the space above the pillar is suitable for installing the communication device 401. If the communication device 401 is installed at the same height, the arrival direction of the spatial optical signal is limited to the horizontal direction. Therefore, the light receiving area of the light receiver constituting the receiver 470 can be reduced, and the device can be simplified. The pair of communication devices 401 transmitting and receiving the spatial optical signal is disposed at a position where at least one communication device 401 receives the spatial optical signal transmitted from the other communication device 401. The pair of communication devices 401 may be disposed to transmit and receive spatial optical signals to and from each other. In a case where a communication network of spatial optical signals is configured by a plurality of communication devices 401, the communication device 401 positioned in the middle may be disposed to relay a spatial optical signal transmitted from another communication device 401 to another communication device 401.

According to the present application example, it is possible to perform communication using a spatial optical signal among the plurality of communication devices 401 disposed in the space above the pole. For example, in accordance with the communication among the communication devices 401, communication by radio communication may be performed between the communication device 401 and a radio device or a base station installed in an automobile, a house, or the like. For example, the communication device 401 may be connected to the Internet via a communication cable or the like installed on a pole.

As described above, the communication device according to the present example embodiment includes the reception device, the transmission device, and the communication control device. The transmission device is the transmission device included in any of the transmission devices according to the first and second example embodiments. The reception device receives a spatial optical signal from another communication device. The communication control device acquires a signal based on a spatial optical signal from another communication device received by the reception device. The communication control device executes processing according to the acquired signal. The communication control device causes the transmission device to transmit a spatial optical signal corresponding to the executed processing.

The transmission device included in the communication device according to the present example embodiment transmits a spatial optical signal that is hardly attenuated in an arbitrary direction along a horizontal plane. Therefore, the transmission device of the present example embodiment can transmit a spatial optical signal of stable intensity to a plurality of communication targets arranged in an arbitrary direction along the horizontal plane. That is, according to the present example embodiment, a spatial optical signal for optical spatial communication can be continuously transmitted toward communication targets arranged in an arbitrary direction along the horizontal plane.

A communication system according to an aspect of the present example embodiment includes a plurality of the above-described communication devices. In a communication system, a plurality of communication devices are disposed to transmit and receive spatial optical signals to and from each other. According to the present aspect, it is possible to achieve a communication network that transmits and receives a spatial optical signal.

### Fifth Example Embodiment

Next, a transmitter according to a fifth example embodiment will be described with reference to the drawings. The transmitter of the present example embodiment has a simplified configuration of the transmitters included in the transmission devices of the first to third example embodiments. Hereinafter, the transmitter of the present example embodiment will be described based on the configuration of the transmitter included in the transmission device according to the first example embodiment.

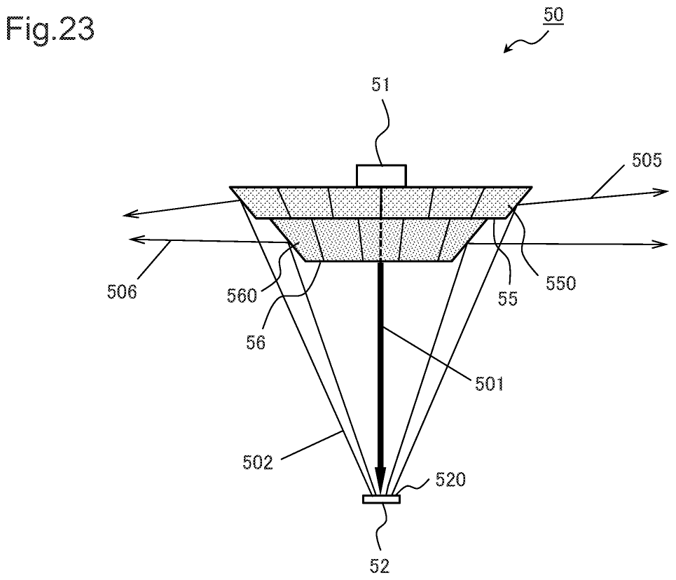

FIG. 23 is a conceptual diagram illustrating an example of a configuration of a transmitter 50 according to the present example embodiment. The transmitter 50 includes a light source 51, a spatial light modulator 52, a first annular mirror array 55, and a second annular mirror array 56. The light source 51 emits illumination light 501. The spatial light modulator 52 includes a modulation part 520 to be irradiated with the illumination light 501 emitted from the light source 51. The spatial light modulator 52 emits the modulation light 502 modulated by the modulation part 520 toward at least one of the first annular mirror array 55 and the second annular mirror array 56. The first annular mirror array 55 includes a plurality of reflectors arranged in an annular shape around the optical axis of the illumination light 501. The second annular mirror array 56 includes a plurality of reflectors arranged in an annular shape around the optical axis of the illumination light 501 in a region inside the first annular mirror array 55 in plan view. The plurality of reflectors constituting the first annular mirror array 55 and the second annular mirror array 56 are arranged such that the modulation light 502 emitted from the spatial light modulator 52 is reflected laterally. The reflecting surfaces 560 of the plurality of reflectors constituting the second annular mirror array 56 are oriented in a direction including a blind region of any reflecting surface 550 of the plurality of reflectors constituting the first annular mirror array 55. The light (projection light 505) reflected by the reflecting surface 550 of the first annular mirror array 55 and the light (projection light 506) reflected by the reflecting surface 560 of the second annular mirror array 56 are transmitted as spatial optical signals.

The transmitter of the present example embodiment includes a first annular mirror array and a second annular mirror array configured by a plurality of reflectors. As the transmitter of the present example embodiment, a reflector having a large radius of curvature of the reflecting surface can be used as compared with a case where an annular mirror including one reflecting surface having a curvature in a horizontal plane is used. According to the transmitter of the present example embodiment, since the projection angle in the horizontal plane can be reduced, and according to the present example embodiment, the spatial optical signal can be transmitted in an arbitrary direction along the horizontal plane by compensating the blind region of the first annular mirror array with the second annular mirror array. That is, according to the transmitter of the present example embodiment, a spatial optical signal that is hardly attenuated can be transmitted in an arbitrary direction along the horizontal plane.

### (Hardware)

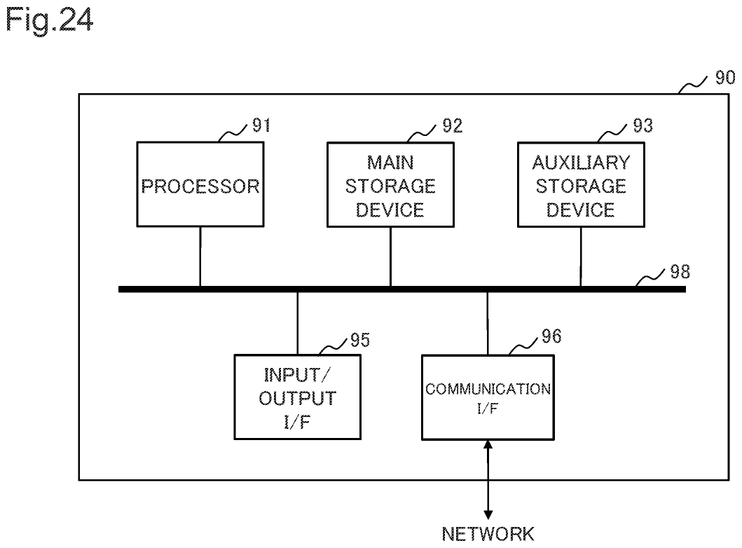

Next, a hardware configuration for executing control and processing according to each example embodiment of the present disclosure will be described with reference to the drawings. Here, an example of such a hardware configuration is an information processing device 90 (computer) in FIG. 24. The information processing device 90 in FIG. 24 is a configuration example for executing the control and processing of each example embodiment, and does not limit the scope of the present disclosure.

As illustrated in FIG. 24, the information processing device 90 includes a processor 91, a main storage device 92, an auxiliary storage device 93, an input/output interface 95, and a communication interface 96. In FIG. 24, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing of each example embodiment. The processor 91 executes the program developed in the main storage device 92. The processor 91 executes the control and processing according to each example embodiment by executing the program.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magneto resistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing according to each example embodiment of the present disclosure. The hardware configuration of FIG. 24 is an example of a hardware configuration for executing the control and processing of each example embodiment, and does not limit the scope of the present disclosure. A program for causing a computer to execute the control and processing according to each example embodiment is also included in the scope of the present disclosure.

Further, a program recording medium in which the program according to each example embodiment is recorded is also included in the scope of the present disclosure. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be made in any combination. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source that emits illumination light;
a first annular mirror array that includes a plurality of reflectors arranged in an annular shape around an optical axis of the illumination light;
a second annular mirror array that includes a plurality of reflectors arranged in an annular shape around an optical axis of the illumination light in a region inside the first annular mirror array in plan view; and
a spatial light modulator that includes a modulation part that emits the illumination light emitted from the light source, and emits the modulation light modulated by the modulation part toward at least one of the first annular mirror array and the second annular mirror array, wherein
the plurality of reflectors constituting the first annular mirror array and the second annular mirror array are arranged in such a way that the modulation light emitted from the spatial light modulator is reflected laterally, and
a reflecting surface of each of the plurality of reflectors constituting the second annular mirror array is oriented in a direction including a blind region of any reflecting surface of the plurality of reflectors constituting the first annular mirror array.

2. The transmitter according to claim 1, wherein
reflecting surfaces of the plurality of reflectors constituting the second annular mirror array are oriented in a direction including boundaries of the plurality of reflectors constituting the first annular mirror array.

3. The transmitter according to claim 2, further comprising:
at least two annular relay mirrors that is formed in an annular shape around an optical axis of the illumination light and that relays and reflect the modulation light emitted from the spatial light modulator toward at least one of the first annular mirror array and the second annular mirror array.

4. The transmitter according to claim 2, comprising:
a first annular relay mirror formed in an annular shape around an optical axis of the illumination light; and
a second annular relay mirror formed in an annular shape around an optical axis of the illumination light in a region outside the first annular relay mirror in plan view, wherein
the first annular relay mirror is disposed on an optical path of the modulation light modulated by the spatial light modulator and reflects the modulation light applied to a reflecting surface toward a reflecting surface of the second annular relay mirror, and
the second annular relay mirror is disposed on an optical path of the modulation light reflected on a reflecting surface of the first annular relay mirror and reflects the modulation light applied to a reflecting surface toward at least one of the first annular mirror array and the second annular mirror array.

5. The transmitter according to claim 1, comprising:
a pillar avoiding mirror disposed at a position to reflect the modulation light while avoiding a pillar of a housing that houses the light source, the spatial light modulator, the first annular mirror array, and the second annular mirror array.

6. A transmission device comprising:
a transmitter according to claim 1; and
a communication controller comprising a memory storing instructions, and a processor connected to the memory and configured to execute the instructions to
set a phase image used for spatial light communication in the modulation part of the spatial light modulator included in the transmitter, and
control the light source included in the transmitter in such a way that the illumination light is emitted to the modulation part in which the phase image is set.

7. The transmission device according to claim 6, wherein
the light source includes a plurality of emitters,
a plurality of modulation regions are set in the modulation part of the spatial light modulator,
each of a plurality of the emitters is associated with one of a plurality of the modulation regions, and
the processor of the communication controller is configured to execute the instructions to
control the spatial light modulator in such a way that the modulation light modulated in each of a plurality of the modulation regions is emitted to a reflector associated with each of a plurality of communication targets among reflectors constituting each of the first annular mirror array and the second annular mirror array in a mode of simultaneously communicating with the plurality of communication targets; and
control the spatial light modulator in such a way that the modulation light modulated in each of a plurality of the modulation regions is emitted to a single reflector among reflectors constituting each of the first annular mirror array and the second annular mirror array in a mode of searching for a communication target.

8. The transmission device according to claim 6, wherein
the transmitter includes a photodetector that detects the modulation light reflected by one of the reflectors of the first annular mirror array and the second annular mirror array, and
the processor of the communication controller is configured to execute the instructions to
control, in an optical power measuring mode, the spatial light modulator in such a way that the modulation light modulated by the spatial light modulator is emitted toward the photodetector,
measure optical power of the modulation light detected by the photodetector, and
adjust power of the light source according to the measured optical power of the modulation light.

9. A communication device comprising:
a transmitter according to claim 1;
a receiver that receives a spatial optical signal transmitted from another communication target; and
communication controller comprising a memory storing instructions, and a processor connected to the memory and configured to execute the instructions to
acquire a signal based on a spatial optical signal from the other communication device received by the receiver,
execute processing according to the acquired signal, and
cause the transmitter to transmit a spatial optical signal toward the other communication target.

10. A communication system comprising:
a plurality of communication devices according to claim 9, wherein
a plurality of the communication devices are disposed to transmit and receive spatial optical signals to and from each other.
